(19) United States
(12) Patent Application Publication
(10) Pub. No.: US 2016/0063216 A1
(43) Pub. Date: Mar. 3, 2016

(54) BIOLOGICAL INFORMATION DETECTING APPARATUS, BIOLOGICAL INFORMATION DETECTING SYSTEM, AND CONTROL METHOD FOR BIOLOGICAL INFORMATION DETECTING APPARATUS

(71) Applicant: Seiko Epson Corporation, Tokyo (JP)

(72) Inventor: Hironori Hasei, Azumino-shi (JP)

(21) Appl. No.: 14/746,415

(22) Filed: Jun. 22, 2015

(30) Foreign Application Priority Data
Aug. 27, 2014 (JP) 2014-172843
Apr. 22, 2015 (JP) 2015-087439

(51) Int. Cl. G06F 19/00

(52) U.S. Cl. CPC G06F 19/366

(57) ABSTRACT

A biological information detecting apparatus is a biological information detecting apparatus that detects biological information of a user. The biological information detecting apparatus includes a biological-information detecting unit configured to detect the biological information, a clocking unit configured to clock a present date and time, a storing unit configured to store time limit information concerning a return time limit of the biological information detecting apparatus, and an notifying unit configured to notify a comparison result of the return time limit and the present date and time clocked by the clocking unit.

This application claims priority to Japanese Patent Application No. 2014-172843, filed Aug. 27, 2014, and 2015-087439, filed Apr. 22, 2015, the entirety of which are hereby incorporated by reference.

### BACKGROUND

1. Technical Field

The present invention relates to a biological information detecting apparatus, a biological information detecting system, and a control method for the biological information detecting apparatus.

2. Related Art

There has been known a biological information analysis supporting system that provides an analysis report concerning biological information of a patient (a user) measured in a home of the patient using a biological information measuring apparatus (e.g., JP-A-2002-291707 (Patent Literature 1).

The biological information analysis supporting system described in Patent Literature 1 includes a server (a biological information analysis supporting apparatus) used by a service provider, the biological information measuring apparatus rented to the patient, a terminal apparatus in the patient's home, and a terminal in a hospital. The server communicates with each of the terminal in the patient's home and the terminal in the hospital. In the biological information analysis supporting system, data of the biological information measuring apparatus used by the patient (the user) is transmitted from the terminal in the patient's home to the server. The server receives the data of the biological information measuring apparatus, generates a report corresponding to the data, and transmits the report to the terminal in the hospital.

For example, in a configuration like the biological information analysis supporting system described in Patent Literature 1, when the measuring apparatus is rented from the service provider (a rental company), in general, a use time limit (a return time limit) of the biological information measuring apparatus is set.

However, it is likely that the biological information measuring apparatus is not returned to the rental company because, for example, the user forgets the return time limit set in advance.

### SUMMARY

An advantage of some aspects of the invention is to solve at least a part of the problems described above and provide a biological information detecting apparatus, a biological information detecting system, and a control method for the biological information detecting apparatus with which a return time limit can be easily recognized.

A first aspect of the invention is directed to a biological information detecting apparatus that detects biological information of a user. The biological information detecting apparatus includes: a biological-information detecting unit configured to detect the biological information; a clocking unit configured to clock a present date and time; a storing unit configured to store time limit information concerning a return time limit of the biological information detecting apparatus; and an notifying unit configured to notify a comparison result of the return time limit and the present date and time clocked by the clocking unit.

Examples of the biological information include a pulse wave, a brain wave, a cardiogram, and a body temperature. Examples of the time limit information include a date of return of the biological information detecting apparatus and a rental period and a period of use from a renting date. Examples of the comparison result include the number of days to the date of return of the biological information detecting apparatus.

According to the first aspect, it is possible to inform, with the notifying unit, the comparison result of the time limit information and the present date and time, for example, the number of days to the date of return of the biological information detecting apparatus. Consequently, the user can easily recognize the return time limit.

In the first aspect, it is preferable that the biological information detecting apparatus further includes a time-limit adjusting unit configured to adjust the time limit information on the basis of a detection progress state of the biological information detecting apparatus.

Note that examples of information indicating the detection progress state include an operation time of the biological information detecting apparatus and a detection time and an information amount of information by the biological information detecting apparatus.

According to the first aspect with the configuration described above, the time limit information is adjusted on the basis of the detection progress state of the biological information detecting apparatus. Therefore, for example, if the detection progress state is unfavorable, it is possible to adjust, with the time-limit adjusting unit, the time limit information to extend the return time limit of the biological information detecting apparatus. On the other hand, if the detection progress information is satisfactory, it is possible to adjust the time limit information to reduce the return time limit of the biological information detecting apparatus. That is, in both the cases, it is possible to increase likelihood that the biological information detecting apparatus is returned in a state in which biological information of the user is surely detected by the biological information detecting apparatus.

Even when the time limit information is adjusted by the time-limit adjusting unit, a comparison result of the adjusted time limit information and the present date and time is notified. Therefore, the user can easily grasp the return time limit even when the time limit information is adjusted.

In the first aspect, it is preferable that the biological information detecting apparatus further includes a biological-detection-state-information acquiring unit configured to acquire, as information indicating the detection progress state, biological detection state information concerning at least one of a detection time of the biological information by the biological-information detecting unit and an information amount of the detected biological information, and the time-limit adjusting unit adjusts the time limit information on the basis of the biological detection state information.

According to the first aspect with the configuration described above, the biological detection state information concerning at least one of the detection time and the information amount of the biological information is acquired as the information indicating the detection progress state. It is possible to appropriately grasp the detection progress state using the information concerning at least one of the detection time and the information amount.

For example, even when the number of days to the return time limit is relatively short, if a fixed detection time is secured and biological information of a fixed information amount is detected, it is also possible not to adjust the time limit information.

Consequently, it is possible to adjust the time limit information such that the biological information of the fixed information amount is detected. Therefore, for example, it is possible to prevent the biological information detecting apparatus from being returned before biological information of the user of a degree necessary for an analysis is detected.

In the first aspect, it is preferable that the biological information detecting apparatus further includes a biological-detection-state determining unit configured to determine whether the biological detection state information at the present has reached an acquisition target of the detection progress state, and the time-limit adjusting unit adjusts the time limit information when the biological-detection-state determining unit determines that the biological detection state information at the present does not reach the acquisition target.

When the biological detection state information is an information amount of the biological information, the acquisition target can be a predetermined information amount. When the biological detection state information is information concerning a detection time of the biological information by the biological-information detecting unit, the acquisition target can be a target value concerning the detection time.

According to the first aspect with the configuration described above, when the biological detection state information at the present does not reach the acquisition target, the time limit information is adjusted. Therefore, it is possible to adjust the return time limit such that the biological detection state information reaches the acquisition target before the return time limit. Therefore, it is possible to surely prevent the biological information detecting apparatus from being returned before biological information of an amount necessary for an analysis is detected.

In the first aspect, it is preferable that the notifying unit includes a display unit configured to display the biological information detected by the biological-information detecting unit and a degree of achievement of the biological detection state information at the present with respect to the acquisition target.

According to the first aspect with the configuration described above, the user can simultaneously recognize the degree of achievement and the biological information. Consequently, it is possible to make the user aware of the degree of achievement and urge the user to take action for improving the degree of achievement. Therefore, it is possible to reduce likelihood of adjustment of the time limit information.

In the first aspect, it is preferable that the biological detection state information includes, as the information concerning the detection time of the biological information, at least any one of a total time, which is a total of the detection time, a time-period total time, which is a total of the detection time in a predetermined period of time, and a ratio of the detection time in each period of time in the total time.

According to the first aspect with the configuration described above, the time limit information is adjusted on the basis of anyone of the total time, the time-period total time, and the detection time of the biological information. Therefore, it is possible to adjust the time limit information more in detail. Consequently, it is possible to set a more accurate date of return of the biological information detecting apparatus.

When biological information of a user is detected using the biological information detecting apparatus for an analysis of abnormality that occurs in the user, in the case of a user having the abnormality in an awakening state, if a detection time in the awakening state is shorter than a detection time in a resting state (including sleep), it is likely that a necessary information amount cannot be secured.

On the other hand, for example, by using a time-period total time and a ratio of the detection time in a period of time when the user is in the awakening state as the biological detection state information and as target biological detection state information corresponding to the biological detection state information, it is possible to adjust the time limit information until the necessary information amount is obtained. Therefore, it is possible to surely prevent the biological information detecting apparatus from being returned before biological information of an amount necessary for an analysis is detected.

In the first aspect, it is preferable that the biological information detecting apparatus further includes: a body-motion-information detecting unit configured to detect body motion information of the user; and a body-motion-detection-state-information acquiring unit configured to acquire, as information indicating the detection progress state, body motion detection state information concerning at least one of a detection time of the body motion information by the body-motion-information detecting unit and an information amount of the detected body motion information, and the time-limit adjusting unit adjusts the time limit information on the basis of the body motion detection state information.

According to the first aspect with the configuration described above, as the information indicating the detection progress information, the body motion detection state information concerning at least one of the detection time and the information amount of the body motion information is acquired as the information indicating the detection progress state. It is possible to appropriately grasp the detection progress state using the information concerning at least one of the detection time and the information amount.

For example, even when the number of days to the return time limit of the biological information detecting apparatus is short, if body motion information of a fixed information amount is detected, it is possible not to adjust the time limit information. Consequently, it is possible to adjust the time limit information such that the body motion information of the fixed information amount is detected. Therefore, for example, it is possible to prevent the biological information detecting apparatus from being returned before body motion information of the user of a degree necessary for an analysis is detected.

In the first aspect, it is preferable that the biological information detecting apparatus further includes a body-motion-detection-state determining unit configured to determine whether the body motion detection state information at the present has reached an acquisition target of the detection progress state, and, when the body-motion-detection-state determining unit determines that the body motion detection state information at the present does not reach the acquisition target, the time-limit adjusting unit adjusts the time limit information.

As in the above explanation, when the body motion detection state information is an information amount of the body motion information, the acquisition target can be a predetermined information amount. When the biological detection date information is information concerning a detection time of the body motion information by the body-motion-information detecting unit, the acquisition target can be a target value concerning the detection time.

According to the first aspect with the configuration described above, when the body motion detection state information at the present does not reach the acquisition target, the time limit information is adjusted. Therefore, it is possible to adjust the return time limit such that the biological detection state information reaches the acquisition target before the return time limit. Therefore, it is possible to prevent the biological information detecting apparatus from being returned before body motion information of the user of a degree necessary for an analysis is detected.

In the first aspect, it is preferable that the biological information detecting apparatus includes a transmitting unit configured to transmit a detection result by the biological information detecting apparatus to an external apparatus.

According to the first aspect with the configuration described above, the detection result can be transmitted to the external apparatus via the transmitting unit. Therefore, it is possible to manage, in the external apparatus, information detected by the biological information detecting apparatus. Consequently, for example, it is possible to, for example, accumulate and analyze the detected information with the external apparatus. In this case, since it is unnecessary to perform an analysis and the like based on the detection result in the biological information detecting apparatus, it is possible to attain a reduction in the costs, a reduction in the weight, and a reduction in the size of the biological information detecting apparatus.

In the first aspect, it is preferable that the biological information detecting apparatus further includes a receiving unit configured to receive date and time information indicating a present time, and the clocking unit corrects the clocked present date and time on the basis of the received date and time information.

According to the first aspect with the configuration described above, the clocking unit can correct, on the basis of the received date and time information, the present date and time currently being clocked. Therefore, it is possible to more accurately compare the time limit information and the present date and time. Consequently, it is possible to notify a surer comparison result.

A second aspect of the invention is directed to a biological information detecting system including: the biological information detecting apparatus; and an external apparatus configured to communicate with the biological information detecting apparatus. The biological information detecting apparatus includes an information acquiring unit configured to acquire the time limit information from the external apparatus and causes the storing unit to store the time limit information.

According to the second aspect, it is possible to attain effects same as the effects of the biological information detecting apparatus according to the first aspect. Since the external apparatus can transmit the time limit information, it is unnecessary to input the time limit information to the biological information detecting apparatus in advance. A user of the external apparatus can freely set a time limit.

A third aspect of the invention is directed to a biological information detecting system including: a detecting apparatus rented out to a user and used by the user; and a managing apparatus configured to manage the detecting apparatus. The detecting apparatus includes: a biological-information detecting unit configured to detect biological information of the user; a clocking unit configured to clock a present date and time; a storing unit configured to store time limit information concerning a return time limit of the detecting apparatus; an information acquiring unit configured to acquire the time limit information concerning a return time limit of the detecting apparatus from the managing apparatus; an notifying unit configured to notify a comparison result of the return time limit and the present date and time clocked by the clocking unit; a biological-detection-state-information acquiring unit configured to acquire biological detection state information concerning at least one of a detection time of the biological information by the biological-information detecting unit and an information amount of the detected biological information; a biological-detection-state determining unit configured to determine whether the biological detection state information at the present has reached an acquisition target; and an adjustment requesting unit configured to cause the managing apparatus to adjust the time limit information when the biological detection state information at the present is determined not reach the acquisition target. The managing apparatus includes: an adjustment-request receiving unit configured to receive the request information; a time-limit adjusting unit configured to adjust the time limit information on the basis of the received request information; and an information transmitting unit configured to transmit the adjusted time limit information to the detecting apparatus.

According to the third aspect, it is possible to attain effects same as the effects of the biological information detecting apparatus according to the first aspect and the biological information detecting system according to the second aspect.

Since the time-limit adjusting unit is provided in the managing apparatus, it is unnecessary to adjust the time limit information in the detecting apparatus. Therefore, since the time-limit adjusting unit is not provided in the detecting apparatus, it is possible to reduce manufacturing costs of the detecting apparatus. Further, since the detecting apparatus does not adjust the time limit information, an administrator (e.g., a rental company), which uses the managing apparatus, can surely and appropriately manage the present time limit information of the detecting apparatus.

A fourth aspect is directed to a biological information detecting system including: a detecting apparatus rented out to a user and used by the user; and a managing apparatus configured to manage the detecting apparatus. The detecting apparatus includes: a biological-information detecting unit configured to detect biological information of the user; a clocking unit configured to clock a present date and time; a storing unit configured to store time limit information concerning a return time limit of the detecting apparatus; an information acquiring unit configured to acquire the time limit information concerning a return time limit of the detecting apparatus from the managing apparatus; an notifying unit configured to notify a comparison result of the return time limit and the present date and time clocked by the clocking unit; and a biological-information transmitting unit configured to transmit the biological information detected by the biological-information detecting unit. The managing apparatus includes: a biological-information receiving unit configured to receive the biological information and the biological detection state information; a biological-detection-state determining unit configured to determine whether the biological detection state information at the present including at least one of a detection time of the biological information and an information amount of the detected biological information has reached an acquisition target; a time-limit adjusting unit configured to adjust the time limit information when the biological detection state information at the present is determined not reach the acquisition target; and an information transmitting and outputting unit configured to transmit and output the adjusted time limit information to the detecting apparatus.

According to the fourth aspect, it is possible to attain effects same as the effects of the biological information detecting system according to the third aspect.

Since the biological detection state determining unit is not provided in the detecting apparatus, it is possible to further reduce the manufacturing costs of the detecting apparatus. Further, since the detecting apparatus does not freely adjust the time limit information, an administrator (e.g., a rental company), which uses the managing apparatus, can surely and appropriately manage the present time limit information of the detecting apparatus.

A fifth aspect of the invention is directed to a control method for the biological information detecting apparatus including: determining whether the return time limit has expired; stopping the detection of biological information by the biological-information detecting unit when it is determined that the return time limit has expired; causing, after the detection of biological information is stopped, the user to select whether the return time limit is extended; causing, when the return time limit is extended, the biological-information detecting unit to resume the detection of biological information.

According to the fifth aspect, the detection of biological information is stopped when it is determined that the return time limit has expired, and the detection of biological information is resumed when the user extends the return time limit of the biological information detecting apparatus. Therefore, when the user does not extend the return time limit, it is possible to prevent biological information of the user from being detected. Consequently, when the biological information detecting apparatus is returned while the detection of biological information is stopped, it is possible to prevent unnecessary measurement data from being accumulated. Therefore, it is possible to reduce time of a data analysis of the biological information or the like of the user. When the return time limit of the biological information detecting apparatus is not extended, since the biological information is not detected, it is possible to increase likelihood that the user quickly returns the biological information detecting apparatus. Therefore, when the user does not extend the return time limit of the biological information detecting apparatus, it is possible to increase likelihood that the biological information detecting apparatus is returned. Alternatively, when it is necessary to extend the return time limit, it is possible to urge the user to perform processing for extending the return time limit.

In the fifth aspect, it is preferable that the notifying unit includes a display unit, and, when it is determined that the return time limit has expired, the display unit is caused to display a selection screen for causing the user to select whether the return time limit is extended.

According to the fifth aspect with the configuration described above, the selection screen for selecting whether the return time limit is extended is displayed on the display unit. Therefore, it is possible to easily cause the user to recognize that the return time limit has expired. By causing the user to recognize the selection screen, it is possible to urge the user to extend the return time limit of the biological information detecting apparatus. Therefore, it is possible to surely prevent the biological information detecting apparatus from being returned before biological information of an amount necessary for an analysis is detected.

A sixth aspect of the invention is directed to a control method for the biological information detecting apparatus in which the notifying unit includes a display unit configured to display the biological information. The control method includes: determining whether the return time limit has expired; regulating, when it is determined that the return time limit has expired, the display unit from being caused to display the biological information detected by the biological-information detecting unit; causing, after the display of the biological information is regulated, the user to select whether the return time limit is extended; and causing, when the return time limit is extended, the display unit to display the biological information again.

According to the sixth aspect, it is possible to attain effects same as the effects of the control method for the biological information detecting apparatus according to the fifth aspect. In the control method for the biological information detecting apparatus according to the fifth aspect, when the return time limit of the biological information detecting apparatus has expired, the detection of biological information is stopped. Therefore, for example, when the return time limit of the biological information detecting apparatus is extended, biological information of the user cannot be detected in a period from the stop until the return time limit of the biological information detecting apparatus is extended. On the other hand, in the sixth embodiment, although detected biological information of the user is not displayed, the biological information is continuously detected. Therefore, it is more likely that the return time limit is reduced compared with the fifth aspect. Therefore, it is possible to increase likelihood that the biological information detecting apparatus is returned after biological information of an amount necessary for an analysis is detected.

### BRIEF DESCRIPTION OF THE DRAWINGS

The invention will be described with reference to the accompanying drawings, wherein like numbers reference like elements.

FIG. 1 is a schematic diagram showing a biological information detecting system in a first embodiment of the invention.

FIG. 2 is a block diagram showing the configuration of a biological information detecting apparatus in the first embodiment.

FIG. 3 is a block diagram showing the configuration of a control unit of the biological information detecting apparatus in the first embodiment.

FIG. 4 is a flowchart for explaining notification control processing in the first embodiment.

FIG. 5 is a flowchart for explaining update processing for time limit information in the first embodiment.

FIG. 6 is a flowchart for explaining a procedure of accounting processing executed by an external apparatus in the first embodiment.

FIG. 7 is a block diagram showing the configuration of a control unit of a biological information detecting apparatus in a second embodiment of the invention.

FIG. 8 is a block diagram showing the configuration of a rental company terminal in the second embodiment.

FIG. 9 is a flowchart for explaining update processing for time limit information in the second embodiment.

FIG. 10 is a block diagram showing the configuration of a control unit of a biological information detecting apparatus in a third embodiment of the invention.

FIG. 11 is a block diagram showing the configuration of a rental company terminal in the third embodiment.

FIG. 12 is a flowchart for explaining update processing for time limit information in the third embodiment.

FIG. 13 is a schematic diagram showing a biological information detecting system in a fourth embodiment of the invention.

FIG. 14 is a block diagram showing the configuration of a control unit included in a biological information detecting apparatus configuring a biological information detecting system in a fifth embodiment of the invention.

FIG. 15 is a diagram showing a first message screen stored in advance in a storing unit of the biological information detecting apparatus in the fifth embodiment.

FIG. 16 is a diagram showing a second message screen stored in advance in the storing unit of the biological information detecting apparatus in the fifth embodiment.

FIG. 17 is a flowchart for explaining update processing for time limit information in the fifth embodiment.

FIG. 18 is a block diagram showing the configuration of a control unit included in a biological information detecting apparatus configuring a biological information detecting system in a sixth embodiment of the invention.

FIG. 19 is a diagram showing a third message screen stored in advance in a storing unit of the biological information detecting apparatus in the sixth embodiment.

FIG. 20 is a flowchart for explaining update processing for time limit information in the sixth embodiment.

### DESCRIPTION OF EXEMPLARY EMBODIMENTS

### First Embodiment

A first embodiment of the invention is explained below with reference to the drawings.

### Overview of a Biological Information Detecting System

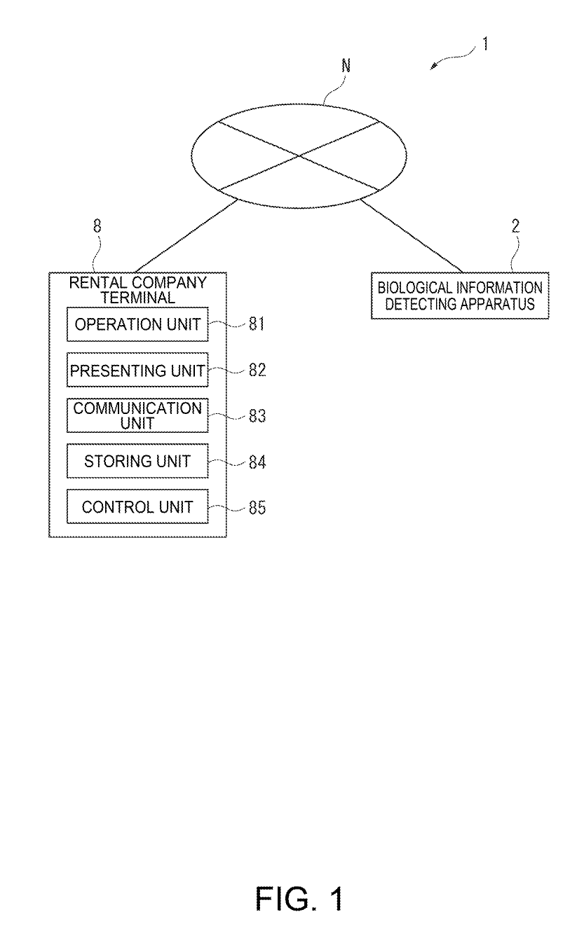

FIG. 1 is a diagram showing the configuration of a biological information detecting system 1 according to this embodiment.

The biological information detecting system 1 includes, as shown in FIG. 1, a biological information detecting apparatus (hereinafter sometimes abbreviated as detecting apparatus) 2 rented to a user by a rental company and a rental company terminal (hereinafter sometimes abbreviated as company terminal) 8 operated by the rental company. The detecting apparatus 2 and the company terminal 8 are capable of communicating with each other via a network N.

### Configuration of the Biological Information Detecting Apparatus

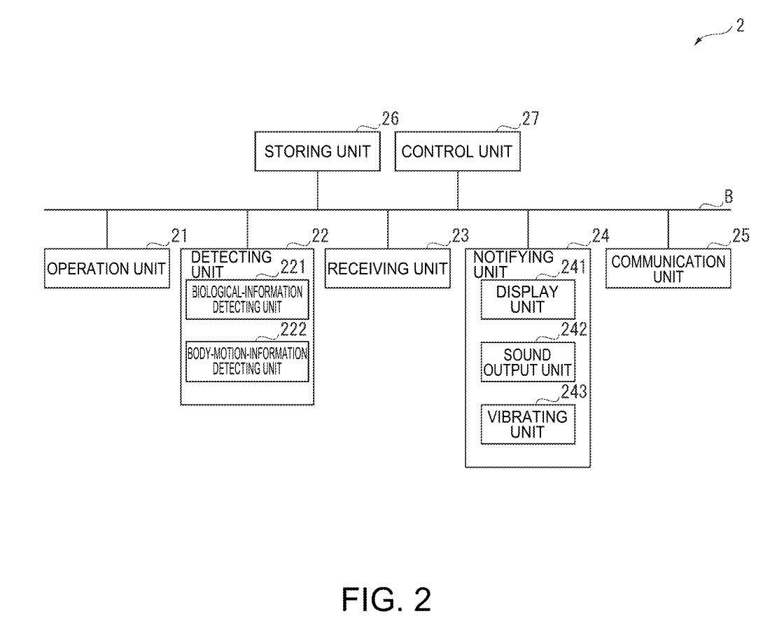

FIG. 2 is a block diagram showing the configuration of the detecting apparatus 2.

The detecting apparatus 2 is a wearable apparatus that is worn on the wrist or the like of a user and detects biological information and body motion information. The detecting apparatus 2 transmits the detected biological information and body motion information to an external apparatus such as the company terminal 8 and notifies the user of a return time limit (a use time limit) of the detecting apparatus 2.

The detecting apparatus 2 includes, as shown in FIG. 2, an operation unit 21, a detecting unit 22, a receiving unit 23, a notifying unit 24, a communication unit 25, a storing unit 26, and a control unit 27. The units 21 to 27 are electrically connected by a bus B.

### Configuration of the Operation Unit

The operation unit 21 receives input operation by the user and outputs operation information corresponding to the input operation to the control unit 27. The operation unit 21 can be configured by, for example, physical keys and a touch panel provided on a housing of the detecting apparatus 2.

### Configuration of the Detecting Unit

The detecting unit 22 includes a biological-information detecting unit 221 and a body-motion-information detecting unit 222 that respectively detect biological information and body motion information of the user.

The biological-information detecting unit 221 detects biological information of the user wearing the detecting apparatus 2. In this embodiment, the biological-information detecting unit 221 detects a brain wave serving as biological information. However, the biological-information detecting unit 221 may be configured to detect other kinds of biological information such as a brain wave, a cardiogram, and a body temperature.

The body-motion-information detecting unit 222 detects, as body motion information of the user, acceleration that changes according to a body motion of the user.

### Configuration of the Receiving Unit

The receiving unit 23 receives a signal (including a signal transmitted in a form of a radio wave) including date and time information indicating the present time. In this embodiment, the receiving unit 23 is configured by, for example, a GPS (Global Positioning System) reception circuit and receives a satellite signal including position information and date and time information transmitted from a positional information satellite (GPS satellite). The receiving unit 23 acquires the date and time information from the received satellite signal and outputs the date and time information to the control unit 27. Alternatively, the receiving unit 23 may be configured to output measurement information of a GPS signal to the control unit 27. The control unit 27 may process the measurement information of the GPS signal and acquire the date and time information.

### Configuration of the Notifying Unit

The notifying unit 24 notifies various kinds of information under the control by the control unit 27. The notifying unit 24 notifies, for example, an operation state of the detecting apparatus 2 and detected information. As explained in detail below, when notifying the information, the notifying unit 24 notifies comparison information indicating a comparison result of the present date and time and a return time limit (e.g., the number of days to a return due date of the detecting apparatus 2) and a ratio of a detection information amount to a target value. The notifying unit 24 includes a display unit 241, a sound output unit 242, and a vibrating unit 243.

The display unit 241 includes a display of a liquid crystal or the like and displays the comparison information.

The sound output unit 242 includes a speaker and outputs sound corresponding to sound information input from the control unit 27.

The vibrating unit 243 includes a motor, driving of which is controlled by the control unit 27, and notifies a state of the detecting apparatus 2 using vibration generated by the driving of the motor.

### Configuration of the Communication Unit

The communication unit 25 is equivalent to the transmitting unit according to the invention and includes a communication module capable of communicating with an external apparatus such as the company terminal 8 via a network N. The communication unit 25 transmits, for example, under the control by the control unit 27, detection information (biological information and body motion information) detected by the detecting unit 22 and stored in the storing unit 26 to the external apparatus. Note that, in this embodiment, the communication unit 25 communicates by radio with a base station and a connection apparatus (e.g., a router) connected to the network N to thereby be connected to the external apparatus for communication. However, the communication unit 25 may be connected to the external apparatus for communication via a relay apparatus such as cradle connected to the network N. When being directly connected to the external apparatus not via the network N, the communication unit 25 may be connected to the external apparatus by radio or by wire.

### Configuration of the Storing Unit

The storing unit 26 is configured by a nonvolatile semiconductor memory such as a flash memory and has stored therein computer programs and data necessary for the operation of the detecting apparatus 2.

The storing unit 26 has stored therein, for example, as the data, connection information for connection for communication to the company terminal 8 via the communication unit 25, detection information (biological information and detection information) detected by the detecting unit 22, a detection time (time when the detecting unit 22 operates) of the detection information, and time limit information including a return time limit set when the detecting apparatus 2 is rented out.

The storing unit 26 has stored therein, for example, as the computer programs, a time limit update program for executing time limit update processing for updating the time limit information and a notification control program for executing notification control processing for causing the display unit 241 to display the comparison information.

Note that, in this embodiment, the time limit information includes a return due date, which is an end date of the return time limit. However, the time limit information is not limited to this and may include a rent start date and a rental period.

### Configuration of the Control Unit

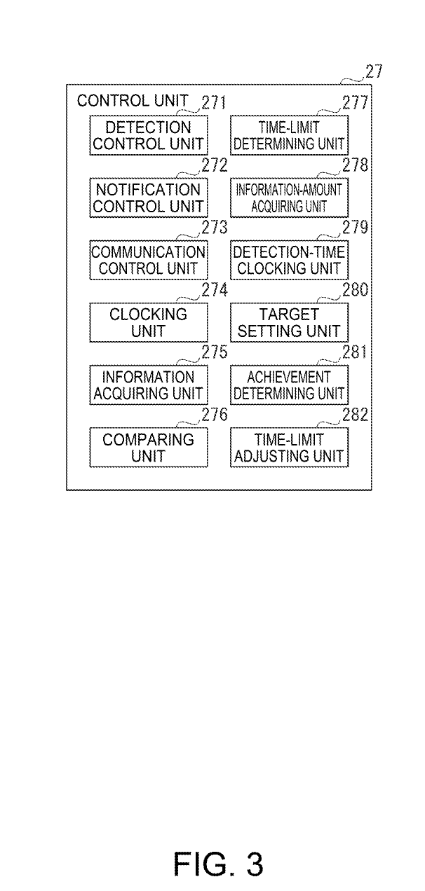

FIG. 3 is a block diagram showing the configuration of the control unit 27. The control unit 27 is configured by a processing circuit such as a CPU (Central Processing Unit) and controls the operation of the detecting apparatus 2 autonomously or according to an operation signal input from the operation unit 21 according to operation by the user. For example, the control unit 27 analyzes biological information and body motion information detected by the detecting unit 22 and transmits the biological information and the body motion information to the company terminal 8. The control unit 27 executes notification control processing for notifying the comparison information and time limit information adjusting processing for adjusting the time limit information.

The control unit 27 includes, as shown in FIG. 3, as functional units realized by the control circuit executing the computer programs stored in the storing unit 26, a detection control unit 271, a notification control unit 272, a communication control unit 273, a clocking unit 274, an information acquiring unit 275, a comparing unit 276, a time-limit determining unit 277, an information-amount acquiring unit 278, a detection-time clocking unit 279, a target setting unit 280, an achievement determining unit 281, and a time-limit adjusting unit 282.

The detection control unit 271 controls the operation of the detecting unit 22 and causes the storing unit 26 to store a detection result by the detecting unit 22 together with the present time clocked by the clocking unit 274. If the detecting apparatus 2 is worn by the user and detection of biological information and body motion information by the detecting unit 22 is possible, the detection control unit 271 causes the detecting unit 22 to detect the information. If the detection of the kinds of information by the detecting unit 22 cannot be executed, the detection control unit 271 stops the operation of the detecting unit 22. Therefore, biological information and body motion information detected after the detecting apparatus 2 is worn by the user are stored in the storing unit 26. When the detecting apparatus 2 is not worn by the user, these kinds of information are not stored.

The notification control unit 272 controls the notifying unit 24. For example, the notification control unit 272 controls the display unit 241 of the notifying unit 24 to display information detected by the detecting unit 22. The notification control unit 272 causes the display unit 241 to display the comparison information generated by the comparing unit 276. That is, present biological information detected by the detecting unit 22 and the comparison information (the number of remaining days to the date of return of the detecting apparatus 2) are displayed on the display unit 241 by the notification control unit 272.

Note that, in this embodiment, the notification control unit 272 displays, as information detected by the detecting unit 22, at least any one of a pulse wave serving as biological information detected by the biological-information detecting unit 221 and a pulse rate (a pulse rate per unit time), a pulse interval, and the like calculated by analyzing the pulse wave. However, the notification control unit 272 is not limited to the configuration for displaying these kinds of biological information and may display, instead of the biological information or in addition to the biological information, an acceleration value detected by the body-motion-information detecting unit 222.

The communication control unit 273 communicates with, on the basis of the connection information stored in the storing unit 26, the company terminal 8 associated with the detecting apparatus 2.

The clocking unit 274 clocks the present time. The clocking unit 274 periodically corrects (e.g., once in twenty-four hours) the present date and time (the present time) on the basis of date and time information received by the receiving unit 23.

The information acquiring unit 275 causes the storing unit 26 to store biological information and body motion information detected by the biological-information detecting unit 221 and the body-motion-information detecting unit 222.

The comparing unit 276 compares the return due date included in the time limit information stored in the storing unit 26 and the present date and time clocked by the clocking unit 274 and generates comparison information indicating a comparison result. Specifically, when the return due date is Aug. 25, 2014 and a date of the present date and time is Aug. 18, 2014, the comparing unit 276 generates comparison information indicating that seven days are left until the return due date.

The time-limit determining unit 277 determines, on the basis of the comparison information generated by the comparing unit 276, whether, for example, less than one day is left until the return due date of the detecting apparatus 2.

The information-amount acquiring unit 278 is equivalent to the biological-detection-state-information acquiring unit and the operation-detection-state-information acquiring unit according to the invention. The information-amount acquiring unit 278 acquires an information amount (e.g., a data size and the number of data) of biological information and an information amount (e.g., a data size and the number of data) of body motion information stored in the storing unit 26.

The detection-time clocking unit 279 is equivalent to the biological-detection-state-information acquiring unit and the body-motion-detection-state-information acquiring unit according to the invention. The detection-time clocking unit 279 clocks detection times of biological information and body motion information by the biological-information detecting unit 221 and the body-motion-information detecting unit 222. In other words, the detection-time clocking unit 279 clocks operation times of the biological-information detecting unit 221 and the body-motion-information detecting unit 222. That is, the detection-time clocking unit 279 clocks total times, which are total detection times of the respective biological-information detecting unit 221 and body-motion-information detecting unit 222, respectively as detection times of the biological information and the body motion information.

Note that the detection-time clocking unit 279 may clock, instead of the total times, time period total times, which are total times of detection times in a predetermined period of time, as the detection times. The detection-time clocking unit 279 may calculate a ratio of the time period total times in the total times and total times of detection times in a period of time other than the predetermined period of time and retain the ratio as information concerning the detection times. When information necessary for an analysis in the company terminal 8 or the like is biological information and body motion information in an awakening state of the user, examples of the predetermined period of time include a period of time from 6 o'clock to 22 o'clock when the user is considered to be in the awakening state. On the other hand, when the information necessary for an analysis in the company terminal 8 or the like is biological information and body motion information in a resting state of the user, examples of the predetermined period of time include a period of time from 22 o'clock to 6 o'clock next morning when the user is considered to be in the resting state (a sleeping state).

The target setting unit 280 sets target values of respective biological information and body motion information. The target values are set according to the return time limit of the detecting apparatus 2 indicated by the time limit information. More specifically, the target values are set to information amounts that the detecting unit 22 can detect before the last day (the return due date) of the return time limit indicated by the time limit information.

For example, the target setting unit 280 sets, as the target values, information amounts of biological information and body motion information that can be acquired before a return time limit set in advance. Specifically, if the number of days to the return time limit (Aug. 25, 2014) is ten days, the target setting unit 280 considers two days among the ten days as reserved days and sets, as target values (100%), information amounts of biological information and body motion information that can be acquired in eight days.

Note that, like the time limit information, the target values may be set in advance using the company terminal 8 or the like when the detecting apparatus 2 is rented out from the rental company. In this case, the detecting apparatus 2 does not have to include the target setting unit 280.

The achievement determining unit 281 is equivalent to the biological-detection-state determining unit and the body-motion-detection-state determining unit according to the invention. The achievement determining unit 281 determines whether present information amounts of respective detected biological information and body motion information reach target values (acquisition targets) corresponding thereto.

Specifically, the achievement determining unit 281 calculates the remaining number of days to the return due date, calculates detected information amounts per one day, and, when values obtained by adding the present information amounts to values obtained by multiplying the information amounts per one day with the remaining number of days exceed the target values, determines that the target values are attained before the return due date. Note that a determination method for target achievement by the achievement determining unit 281 is not limited to this. For example, the achievement determining unit 281 may be configured to compare values obtained by multiplying, with the number of elapsed days to the present, values obtained by dividing the target values by the number of rental days based on the time limit information and acquired data amounts to the present.

The achievement determining unit 281 functions when the time-limit determining unit 277 determines that less than one day is left until the return due date of the detecting apparatus 2. The achievement determining unit 281 determines whether the respective kinds of information reach the target values.

In this embodiment, the achievement determining unit 281 determines whether the present information amount of the biological information detected by the biological-information detecting unit 221 and the present information amount of the body motion information detected by the body-motion-information detecting unit 222 respectively exceed the target values. However, not only this, but the achievement determining may be configured to determine whether at least one of a detection time of biological information to the present by the biological-information detecting unit 221 and a detection time of body motion information to the present by the body-motion-information detecting unit 222 exceeds a target detection time. In this case, the target setting unit 280 only has to set target values of the detection times that can be achieved within the return time limit set when the detecting apparatus 2 is rented out.

The time-limit adjusting unit 282 adjusts the time limit information stored in the storing unit 26. When the time-limit determining unit 277 determines that less than one day is left from the present date until the return due date of the detecting apparatus 2 and the achievement determining unit 281 determines that at least one of information amounts of biological information and body motion information does not reach the target value, the time-limit adjusting unit 282 adjusts the time limit information on the basis of a detection state by the detecting apparatus 2.

For example, when data amount of biological data does not reach the target value, the time-limit adjusting unit 282 updates the time limit information stored in the storing unit 26 to time limit information in which a date obtained by adding, to the return due date indicated by the time limit information, the number of days based on a result obtained by dividing a necessary information amount to the target value (a value obtained by subtracting the present information amount from the target value) by a detection information amount per one day is set as a new return due date. Specifically, when the present information amount of the biological information is 85% with respect to the target value, the time-limit adjusting unit 282 extends (adjusts) the time limit information from Aug. 25, 2014 to Aug. 26, 2014.

On the other hand, when the time-limit determining unit 277 determines that days left from the present date until the return due date of the detecting apparatus 2 are not less than one day and the achievement determining unit 281 determines that the data amounts and the detection times of the biological information and the body motion information reach the target values, the time-limit adjusting unit 282 does not apply update for extending the return due date (or the number of rental days) to the time limit information.

### Notification Control Processing

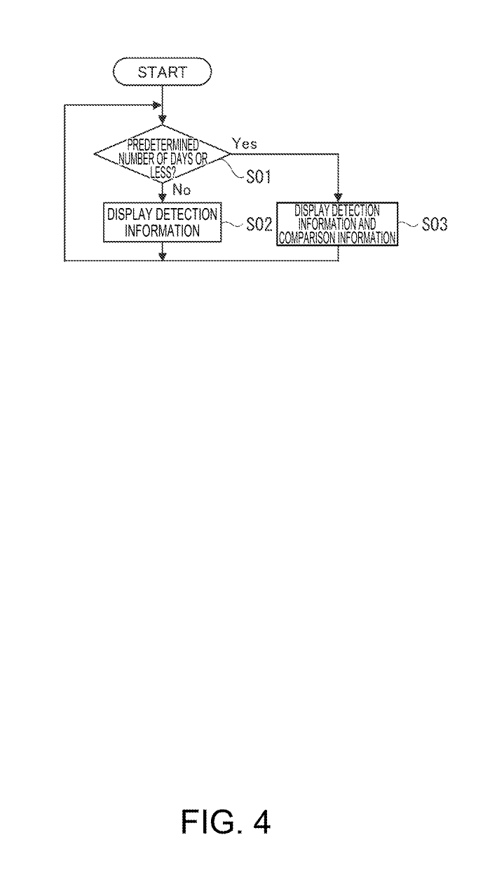

FIG. 4 is a flowchart for explaining notification control processing.

The control unit 27 executes notification control processing explained below on the basis of a computer program stored in the storing unit 26. The notification control processing is processing for causing the display unit 241 configuring the notifying unit 24 to display detection information based on a detection result by the detecting unit 22 and, when only a small number of days are left until the return due date indicated by the time limit information, displaying the comparison information in addition to the detection information. The notification control processing is executed at a predetermined cycle.

Specifically, in the notification control processing, as shown in FIG. 4, first, the time-limit determining unit 277 determines, on the basis of a comparison result by the comparing unit 276, whether the number of days to the return due date indicated by the time limit information is a predetermined number of days or less (step S01).

When it is determined in this determination processing that the number of days to the return due date is larger than the predetermined number of days, the notification control unit 272 causes the display unit 241 to display detection information (e.g., a pulse wave or a pulse rate calculated from the pulse wave) based on a detection result by the detecting unit 22 without causing the display unit 241 to display the comparison information (step S02).

On the other hand, when it is determined in the determination processing that the number of days to the return due date is the predetermined number of days or less, the notification control unit 272 causes the display unit 241 to display the comparison information together with the detection information (step S03).

After steps S02 and S03, the processing is returned to step S01.

When the number of days to the return due date is reduced to be relatively small by the notification control processing, comparison information (e.g., the number of remaining days to the return due date) is displayed. Therefore, it is possible to cause the user to grasp the comparison information.

Note that, in the notification control processing, since the achievement determining unit functions when the number of days to the return due date is less than one day, the predetermined number of days used in the determination processing by the time-limit determining unit is set to the number of days larger than the number of days in which the achievement determining unit functions. Consequently, it is possible to prevent a situation in which the time limit information is updated by update processing explained below and a time limit set when the detecting apparatus 2 is rented out is updated without being displayed at all.

A configuration may be adopted in which the notification control processing is not executed and the comparison information is always displayed together with the detection information.

### Update Control Processing

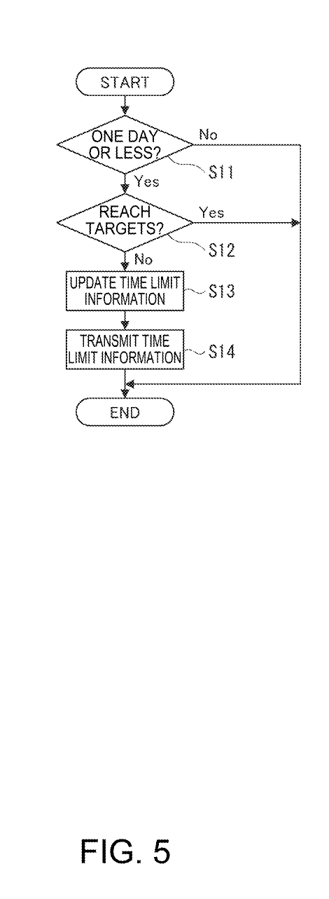

FIG. 5 is a flowchart for explaining update processing.

The control unit 27 executes the update processing explained below on the basis of a computer program stored in the storing unit 26. The update processing is processing for, when it is necessary to update time limit information, updating the time limit information on the basis of detection states of biological information and body motion information by the detecting unit 22.

In the update processing, as shown in FIG. 5, first, the comparing unit 276 compares a date of the present date and time clocked by the clocking unit 274 and the return due date indicated by the time limit information stored in the storing unit 26. The time-period determining unit 277 determines, on the basis of a comparison result by the comparing unit 276, whether the number of days to the return due date of the detecting apparatus 2 is less than one day (step S11). Comparison information (the number of remaining days to the return due date of the detecting apparatus 2) indicating the comparison result is generated.

When it is determined in the determination processing in step S11 that the number of days to the return due date is larger than one day, the control unit 27 ends the update processing.

When it is determined in the determination processing in step S11 that the number of days to the return due date is less than one day, the achievement determining unit 281 determines whether the respective present information amounts of detected biological information and body motion information (the present information amounts of biological information and body motion information stored in the storing unit 26) are about to reach the target values set in advance by the target setting unit 280 (step S12).

When it is determined that the present information amounts of the respective biological information and body motion information are about to reach the respective target values (highly likely to reach the target values), the control unit 27 ends the update processing.

On the other hand, when it is determined in the determination processing in step S12 that at least one of the present information amounts of the respective biological information and body motion information does not reach the target value corresponding thereto, as explained below, the time-limit adjusting unit 282 updates the time limit information stored in the storing unit 26 (step S13).

Thereafter, the communication control unit 273 transmits the time limit information after the update to the company terminal 8 via the communication unit 25 (step S14). After step S14, the control unit 27 ends the update processing.

According to the execution of the update processing, the time limit information is updated according to a detection state of the detecting unit 22 and the return due date is extended. Therefore, when the detecting apparatus 2 is returned, it is possible to secure information amounts necessary for an analysis.

Note that the update processing is executed at a predetermined cycle. However, the update processing only has to be executed once a day. Therefore, for example, the update processing may be repeatedly executed at the same time (e.g., midnight) everyday.

### Configuration of the Rental Company Terminal

The company terminal 8 is equivalent to the external apparatus according to the invention. The company terminal 8 is a terminal apparatus operated by the rental company and can be configured by, for example, a general PC (Personal Computer). The company terminal 8 manages information received from the detecting apparatus 2 rented out by the rental company. Specifically, the company terminal 8 stores information received from the detecting apparatus 2 in association with identification information indicating the detecting apparatus 2. Besides, when the rented-out detecting apparatus 2 is returned, the company terminal 8 executes accounting processing explained below on the basis of the time limit information and a date of return of the detecting apparatus 2.

The company terminal 8 includes, as shown in FIG. 1, an operation unit 81, a presenting unit 82, a communication unit 83, a storing unit 84, and a control unit 85.

The operation unit 81 is configured by operation devices such as a keyboard and a pointing device. The operation unit 81 outputs an operation signal corresponding to input operation to the operation devices to the control unit 85.

The presenting unit 82 includes a display and a speaker and presents various kinds of information to the user using display and a sound output.

The communication unit 83 communicates with the detecting apparatus 2 and transmits and receives information to and from the detecting apparatus 2.

The storing unit 84 has stored therein a computer program and data necessary for the operation of the company terminal 8. Besides the storing unit 84 stores, under the control by the control unit 85, transmission information received from the detecting apparatus 2. The storing unit 84 includes a detection-information storing unit and an accounting-information storing unit.

The detection-information storing unit stores biological information and body motion information included in the transmission information for each of kinds of identification information also included in the transmission information.

The accounting-information storing unit stores a LUT (Lookup Table) that stores, for each of the kinds of identification information of the detecting apparatus 2, time limit information set when the detecting apparatus 2 is rented out, time limit information adjusted (extended) by the detecting apparatus 2, and the number of times of extension. Among these kinds of information, the number of times of extension is incremented every time updated time limit information is received from the detecting apparatus 2.

The control unit 85 controls the operation of the company terminal 8. For example, as explained above, the control unit 85 extracts and acquires various kinds of information from the received transmission information, sets the various kinds of information in the LUT, and stores the LUT. The control unit 85 executes analysis processing for analyzing the acquired biological information and body motion information. Further, the control unit 85 executes accounting processing for calculating a rental fee of the detecting apparatus 2.

Although not shown in the figure, in order to execute the accounting processing, the control unit 85 includes a determining unit that executes various kinds of determination processing, a fee calculating unit that calculates a rental fee, and an output unit that outputs the calculated rental fee.

### Accounting Processing by the Company Terminal

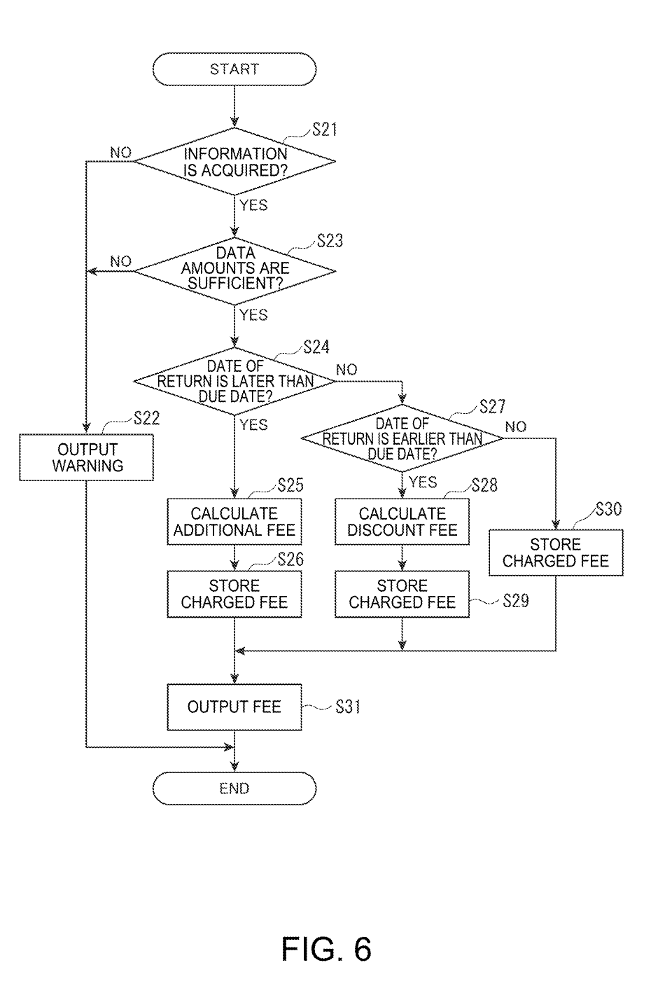

FIG. 6 is a flowchart for explaining the accounting processing by the company terminal 8 connected to the detecting apparatus 2 via the network N.

When the detecting apparatus 2 is returned to the rental company, the company terminal 8 executes, according to operation by the rental company, a computer program stored in the storing unit 84 and executes accounting processing explained below.

In the accounting processing, as shown in FIG. 6, first, the determining unit of the control unit 85 determines whether detection information including biological information and body motion information is acquired from the detecting apparatus 2 (step S21).

When it is determined that the detection information is not acquired, the control unit 85 causes the presenting unit 82 to output a warning to the effect that abnormality occurs (step S22). Thereafter, the control unit 85 ends the accounting processing. Consequently, the rental company can grasp that the detecting apparatus 2 is not in use or the detecting apparatus 2 is out of order.

When it is determined in the determination processing in step S21 that the detection information is acquired, the determining unit determines whether information amounts of the respective acquired biological information and body motion information are sufficient (step S23). Note that the determination of the information amounts by the determining unit can be carried out, for example, by determining whether the information amounts reach target values set by the target setting unit. In this case, when it is determined that the information amounts reach the target values, it is determined that the acquired information amounts are sufficient.

When it is determined that the information amount of at least one of the acquired biological information and the body motion information is insufficient, the control unit 85 shifts the processing to step S22 and causes the presenting unit 82 to output a warning to the effect that the information amount is insufficient. Thereafter, the control unit 85 ends the accounting processing. Consequently, the rental company can recognize that the information amount of the user who returns the detecting apparatus 2 is insufficient and can rent the returned detecting apparatus 2 to the user again.

When it is determined in the determination processing in step S23 that the information amounts of the respective acquired biological information and body motion information are sufficient, the determining unit determines whether a date of return of the detecting apparatus 2 is later than a return due date (a due date) set when the detecting apparatus 2 is rented out (step S24).

When it is determined that the date of return is later than the return due date, the fee calculating unit calculates an additional fee corresponding to the adjusted time limit information, that is, the number of days extended from the original return due date (step S25). The calculation processing for the additional fee is executed using an arithmetic expression stored in the storing unit 26 in advance.

The control unit 85 causes the storing unit 84 to store, as a charged fee, a fee obtained by adding the calculated additional fee to the normal rental fee (step S26). Thereafter, the control unit 85 shifts the processing to step S31.

When it is determined in the determination processing in step S24 that the date of return of the detecting apparatus 2 is not later than the return due date set when the detecting apparatus 2 is rented out, the determining unit of the control unit 85 determines whether the date of return of the detecting apparatus 2 is earlier than the return due date (step S27).

When it is determined that the date of return is earlier than the return due date set when the detecting apparatus 2 is rented out, the fee calculating unit of the control unit 85 calculates a discount fee corresponding to the number of days between the date of return and the return due date (step S28). The calculation processing for the discounted fee is also executed using an arithmetic expression stored in the storing unit 84 in advance.

The control unit 85 causes the storing unit 84 to store, as a charged fee, a fee obtained by subtracting the calculated discount fee from the normal rental fee (step S29). Thereafter, the control unit 85 shifts the processing to step S31.

When it is determined in the determination processing in step S27 that the date of return of the detecting apparatus 2 is not earlier than the return due date set when the detecting apparatus 2 is rented out, that is, when the date of return is the same date as the return due date, the control unit 85 causes the storing unit 84 to store the normal rental fee as a charged fee (step S30). Thereafter, the control unit 85 shifts the processing to step S31.

In step S31, the control unit 85 outputs the respective charged fee calculated and stored in the storing unit 84 to the presenting unit 82. Consequently, the rental company, which operates the company terminal 8, can grasp the charged fee.

The charging processing is ended.

### Effects of the First Embodiment

The biological information detecting system 1 according to this embodiment explained above has effects explained below.

According to this embodiment, by displaying the number of days to the return due date of the detecting apparatus 2 on the display unit 241, it is possible to notify the user of the number of days to the date of return of the detecting apparatus 2. Consequently, the user can easily recognize the return time limit.

According to this embodiment, the time limit information is adjusted on the basis of the detection progress state of the detecting apparatus 2, that is, detection states of biological information and body motion information. Therefore, if the detection state of the biological information and the body motion information are unfavorable, it is possible to adjust, with the time-limit adjusting unit 282, the return time limit of the detecting apparatus 2 to be extended. On the other hand, if the detection states of the biological information and the body motion information are satisfactory, it is possible to adjust the return time limit of the detecting apparatus 2 not to be extended. That is, in both the cases, it is possible to increase likelihood that the detecting apparatus 2 is determined in a state in which biological information and body motion information of the user are surely detected by the detecting apparatus 2.

As information indicating the detection progress state, biological detection state information concerning a detection time and an information amount of the biological information is acquired. It is possible to appropriately grasp the detection progress state according to the information concerning the detection time and the information amount.

For example, even when the number of days to the return time limit is relatively short, if a fixed detection time is secured and biological information of a fixed information amount is detected, it is possible not to adjust the time limit information. Consequently, it is possible to adjust the time limit information such that the biological information of the fixed information amount is detected. Therefore, for example, it is possible to prevent the detecting apparatus 2 from being returned before biological information of the user of a degree necessary for an analysis is detected.

According to this embodiment, when the present biological detection state information does not reach an acquisition target, that is, when information amounts of biological information and body motion information do not reach target values, time limit information is adjusted by the time-limit adjusting unit 282. Therefore, a return time limit can be adjusted such that the information amounts of the biological information and the body motion information satisfy the target values before the return time limit. Therefore, it is possible to surely prevent the detecting apparatus 2 from being returned before biological information and body motion information of amounts necessary for an analysis are detected.

Since a detection result can be output to the outside via the communication unit 25, information (biological information and body motion information) detected by the detecting apparatus 2 can be managed on the outside. Consequently, it is possible to, for example, accumulate and analyze the detected information with the company terminal 8. In this case, since it is unnecessary to perform an analysis and the like based on the detection result in the detecting apparatus 2, it is possible to attain a reduction in the costs, a reduction in the weight, and a reduction in the size of the detecting apparatus 2.

According to this embodiment, the clocking unit 274 can correct, on the basis of received date and time information, the present date and time currently being clocked. Therefore, it is possible to more accurately compare time limit information and the present date and time. Consequently, it is possible to detect a surer comparison result.

In the biological information detecting system 1 in this embodiment, when time limit information is adjusted in the detecting apparatus 2, an additional fee or a discount fee is calculated in the company terminal 8. A charged fee is stored in the storing unit 84. Therefore, the rental company can surely charge the user, which rents the detecting apparatus 2, an increased fee or a discounted fee.

### Modification of the First Embodiment

In the biological information detecting system 1, when an information amount of biological information and body motion information detected by the detecting unit 22 do not reach target values of the respective biological information and body motion information, the detecting apparatus 2 extends a return time limit. On the other hand, the time limit information may be adjusted such that a return time limit is extended when at least one of the information amounts of the biological information and the body motion information does not reach the target value.

The time limit information may be adjusted such that the return time limit is extended when it is determined that at least one of detection times of the respective biological information and body motion information by the detecting unit 22 does not reach a target value (a target time) corresponding to the detection time. In this case, as explained above, the detection time can be a total time as in the embodiment. Besides, the detection times can be time period total times in a predetermined period of time. A ratio of the time period total times in total times and total times of detection times in a period of time other than the predetermined period of time may be further added as a condition. Even when the total times exceed a predetermined time, when it is determined that the ratio does not satisfy a predetermined ratio, the return time limit may be extended.

Consequently, the time limit information is adjusted on the basis of one of the total times of the biological information and the body motion information and the ratio of the time period total times and the detection times. Therefore, it is possible to adjust the time limit information more in detail. Therefore, it is possible to set a more accurate date of return of the detecting apparatus 2. Specifically, for example, it is possible to prevent a situation in which, although biological information and body motion information measured at night (22 o'clock to 6 o'clock) are needed, biological information and body motion information measured in the daytime are stored by wearing the detecting apparatus 2 in the daytime (6 o'clock to 18 o'clock), but, since the detecting apparatus 2 is often not worn at night, information amounts (data amounts) of the biological information and the body motion information are sufficient but data in a necessary period of time is not measured. Consequently, it is possible to surely acquire biological information and body motion information in the necessary period of time.

On the other hand, in the embodiment, the notification control unit 272 causes the display unit 241 to display the comparison information. However, not only this, but, for example, time limit information (e.g., a return due date of the detecting apparatus 2) may be displayed instead of the comparison information or in addition to the comparison information.

### Second Embodiment

A second embodiment of the invention is explained.

A biological information detecting system according to this embodiment includes a configuration same as the configuration of the biological information detecting system 1. In the biological information detecting system 1, the detecting apparatus 2 executes the update processing to adjust and update time limit information and transmits the updated time limit information to the company terminal 8. On the other hand, in the biological information detecting system according to this embodiment, a company terminal adjusts time limit information on the basis of request information received from a detecting apparatus. The detecting apparatus receives the adjusted time limit information and updates time limit information stored in a storing unit. The biological information detecting system and the biological information detecting system 1 are different in this point. Note that, in the following explanation, portions the same as or substantially the same as the portions explained above are denoted by the same reference numerals and signs and explanation of the portions is omitted.

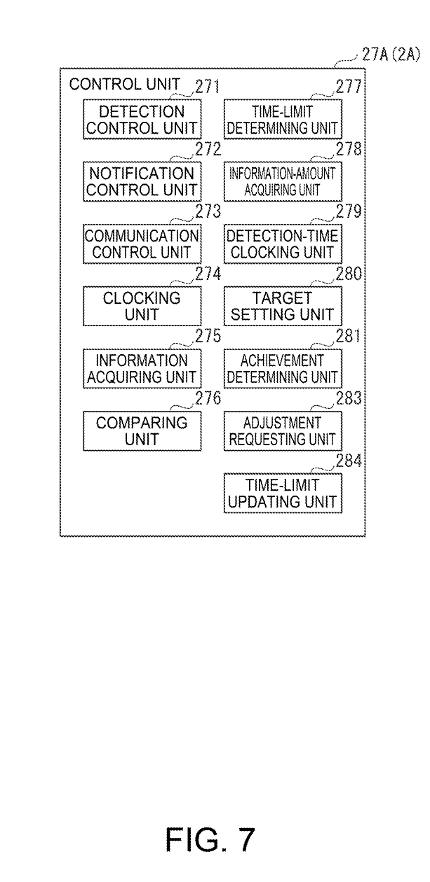

FIG. 7 is a block diagram showing the configuration of a control unit 27A of a detecting apparatus 2A configuring the biological information detecting system according to this embodiment.

The biological information detecting system according to this embodiment includes the biological information detecting apparatus 2A and a company terminal 8A connected to each other for communication via the network N. The biological information detecting system functions in the same manner as the biological information detecting system 1.

The detecting apparatus 2A includes components and functions same as the components and the functions of the detecting apparatus 2 except that the detecting apparatus 2A includes the control unit 27A instead of the control unit 27. That is, in the detecting apparatus 2A as well, the notification control processing is executed.

As shown in FIG. 7, the control unit 27A includes components and functions same as the components and the functions of the control unit 27 except that the control unit 27A includes an adjustment requesting unit 283 and a time-limit updating unit 284 instead of the time-limit adjusting unit 282. Note that, in this embodiment, the target values are set together with the time limit information when the detecting apparatus 2A is rented out from a rental company. Therefore, the target setting unit 280 does not have to be provided in the detecting apparatus 2A. However, the target setting unit 280 is necessary when the detecting apparatus 2A sets the target values. In this embodiment, the detecting apparatus 2A may include the achievement determining unit 281 or a company terminal 8A explained below may include the achievement determining unit 281.

The adjustment requesting unit 283 functions when the time-limit determining unit 277 determines that the number of days to a return due date is a predetermined number of times, for example, less than one day and when the achievement determining unit 281 determines that detected information amounts do not reach the target values. The adjustment requesting unit 283 transmits request information for requesting adjustment of time limit information to the company terminal 8A.

The period updating unit 284 updates, on the basis of the time limit information received by the communication unit 25 from the company terminal 8A and adjusted by the company terminal 8A, the time limit information stored in the storing unit 26. Note that, in this embodiment, the detecting unit 2A may include the time-limit updating unit 284 or the company terminal 8A may include the time-limit updating unit 284.

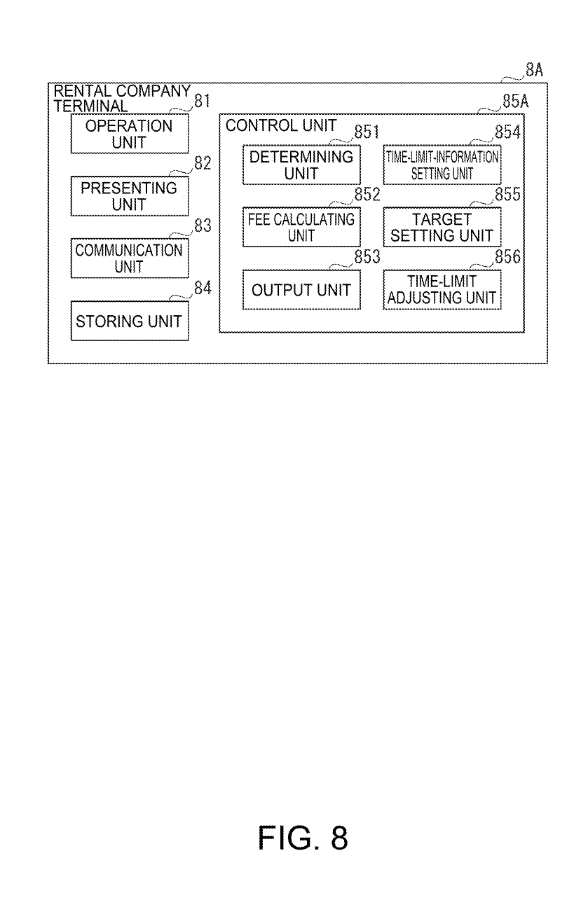

FIG. 8 is a block diagram showing the configuration of the rental company terminal 8A.

As shown in FIG. 8, the company terminal 8A includes components and functions same as the components and the functions of the company terminal 8 except that the company terminal 8A includes a control unit 85A instead of the control unit 85.

Like the control unit 85, the control unit 85A includes a determining unit 851 that executes various kinds of determination processing, a fee calculating unit 852 that calculates a rental fee, and an output unit 853 that outputs the calculated rental fee. Besides, the control unit 85A includes a time-limit-information setting unit 854, a target setting unit 855, and a time-limit adjusting unit 856.

The time-limit-information setting unit 854 sets, according to input operation of a user (a rental company) of the company terminal 8A, time limit information of the detecting apparatus 2A to be rent out and transmits, with the communication unit 83, the set time limit information to the detecting apparatus 2A. When the time limit information is received by the detecting apparatus 2A, the time limit information is stored in the storing unit 26.

The target setting unit 855 functions in the same manner as the target setting unit 280, sets target values of respective biological information and body motion information detected by the detecting apparatus 2A to be rented out, and transmits, with the communication unit 83, the target values to the detecting apparatus 2A. Note that, in this embodiment as well, predetermined information amounts are set as the target values. It is determined on the basis of information amounts of the respective detected biological information and body motion information whether the time limit information is adjusted. However, as explained above, when detection times of the respective biological information and body motion information are determined, predetermined times are set as the target values.

When the request information for requesting the adjustment of the time limit information is received from the detecting apparatus 2A, the time-limit adjusting unit 856 adjusts the time limit information and transmits, with the communication unit 83, the adjusted time limit information to the detecting apparatus 2A. In this case, when, like the time-limit adjusting unit 282, the time-limit adjusting unit 856 adjusts the time limit information on the basis of the present information amounts of the biological information and the body motion information detected by the detecting apparatus 2A or detection times of the biological information and the body motion information and the target values set by the target setting unit 855, the biological information and the body motion information detected by the detecting apparatus 2A and present information amounts and detection times of the biological information and the body motion information only have to be acquired from the detecting apparatus 2A in advance. Alternatively, the time-limit adjusting unit 856 may adjust the time limit information by adding the number of days set in advance to a return due date.

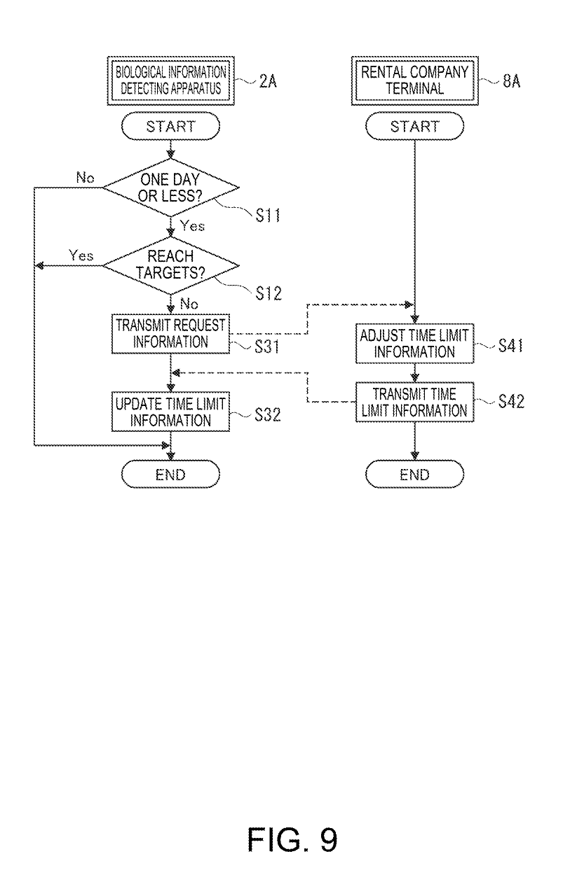

FIG. 9 is a flowchart for explaining update processing for time limit information executed in the biological information detecting system according to this embodiment.

In the biological information detecting system according to this embodiment, the detecting apparatus 2A, which is rented out in a state in which the time limit information and the target values are set, executes update processing explained below in conjunction with the company terminal 8A and performs update of the time limit information according to necessity.

In the update processing, as shown in FIG. 9, the control unit 27 executes step S11 at a predetermined cycle (e.g., once a day). That is, the time-limit determining unit 277 determines, on the basis of a comparison result by the comparing unit 276, whether the number of days to a return due date of the detecting apparatus 2A is less than one day.

When it is determined in the determination processing in step S11 that the number of days to the return due date exceeds one day, the control unit 27 ends the update processing.

When it is determined in the determination processing in step S11 that the number of days to the return due date is less than one day, the achievement determining unit 281 determines whether present information amounts of respective detected biological information and body motion information (present information amounts of biological information and body motion information stored in the storing unit 26) are about to reach the target values (step S12).

When it is determined in the determination processing in step S12 that the present information amounts of the respective biological information and body motion information reach the respective target values, the control unit 27 ends the update processing.

When it is determined in the determination processing in step S12 that at least one of the present information amounts of the respective biological information and body motion information does not reach the target value corresponding thereto, the adjustment requesting unit 283 transmits, with the communication unit 25, the request information for requesting adjustment of the time limit information to the company terminal 8A (step S31).

Thereafter, the control unit 27A shifts the processing to step S32.

On the other hand, in the company terminal 8A, when the request information is received, as explained above, the time-limit adjusting unit 856 adjusts the time limit information set in the detecting apparatus 2A that transmits the request information (step S41). In this case, the time limit information after the adjustment is stored in the LUT. The number of times of extension, which is one of items of the LUT, is incremented by 1.

Thereafter, the time-limit adjusting unit 856 transmits, with the communication unit 83, the time limit information after the adjustment to the detecting apparatus 2A that transmits the request information (step S42).

Consequently, the update processing in the company terminal 8A is ended.

In step S32, the time-limit updating unit 284 of the detecting apparatus 2A updates, on the basis of the time limit information after the adjustment received from the company terminal 8A, the time limit information stored in the storing unit 26 (step S32).

Consequently, the update processing in the detecting apparatus 2A is ended.

By executing the update processing, it is possible to share the time limit information after the adjustment in the detecting apparatus 2A and the company terminal 8A.

### Effects of the Second Embodiment

With the biological information detecting system according to this embodiment explained above, it is possible to attain effects same as the effects of the biological information detecting system 1. Besides, it is possible to attain effects explained below.

In this embodiment, the biological information detecting system is configured by the detecting apparatus 2A and the company terminal 8A that communicates with the detecting apparatus 2A via the network A. Time limit information transmitted from the company terminal 8A is stored in the storing unit 26 of the detecting apparatus 2A. Therefore, the rental company can more surely perform rental time limit management of the detecting apparatus 2A. Since it is unnecessary to provide the time-limit adjusting unit 282 in the detecting apparatus 2A, it is possible to attain a reduction in the costs, a reduction in the weight, and a reduction in the size of the detecting apparatus 2A compared with the detecting apparatus 2.

Further, since the time limit information cannot be changed on the detecting apparatus 2A side, the user of the detecting apparatus 2A can surely detect biological information and body motion information before a return time limit set by the rental company. That is, the user cannot adjust the time limit information by operating the detecting apparatus 2A. Therefore, a rental period does not end unless data amount of biological information and body motion information and detection times of the biological information and the body motion information satisfy target values. Therefore, it is possible to urge the user of the detecting apparatus 2A to quickly detect biological information and body motion information.

Note that, as explained in the modification of the first embodiment, in the biological information detecting system according to this embodiment, the return time limit may be extended when one of information amounts of biological information and body motion information detected by the detecting unit 22 does not reach a target value.

The time limit information may be adjusted when it is determined that at least one of detection times of the respective biological information and body motion information by the detecting unit 22 does not reach a target value (a target time) corresponding to the detection time.

Further, time limit information (e.g., a return due date of the detecting apparatus 2) may be displayed instead of comparison information displayed on the display unit 241 or in addition to the comparison information.

### Third Embodiment

A third embodiment of the invention is explained.

A biological information detecting system according to this embodiment includes components and functions same as the components and the functions of the biological information detecting system 1. However, the biological information detecting system is different from the biological information detecting system 1 in that a company terminal executes determination concerning whether time limit information is updated and adjustment of the time limit information. Note that, in the following explanation, portions the same as or substantially the same as the portions explained above are denoted by the same reference numerals and signs and explanation of the portions is omitted.

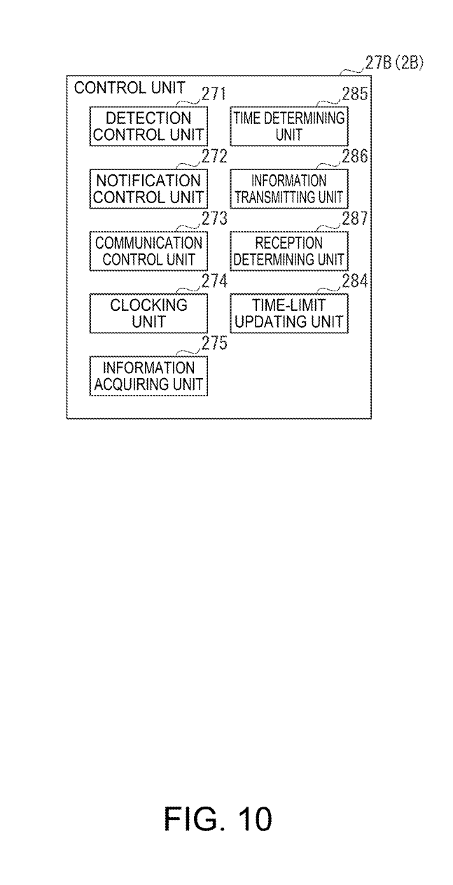

FIG. 10 is a block diagram showing the configuration of a control unit 27B included in a biological information detecting apparatus 2B configuring the biological information detecting system according to this embodiment.

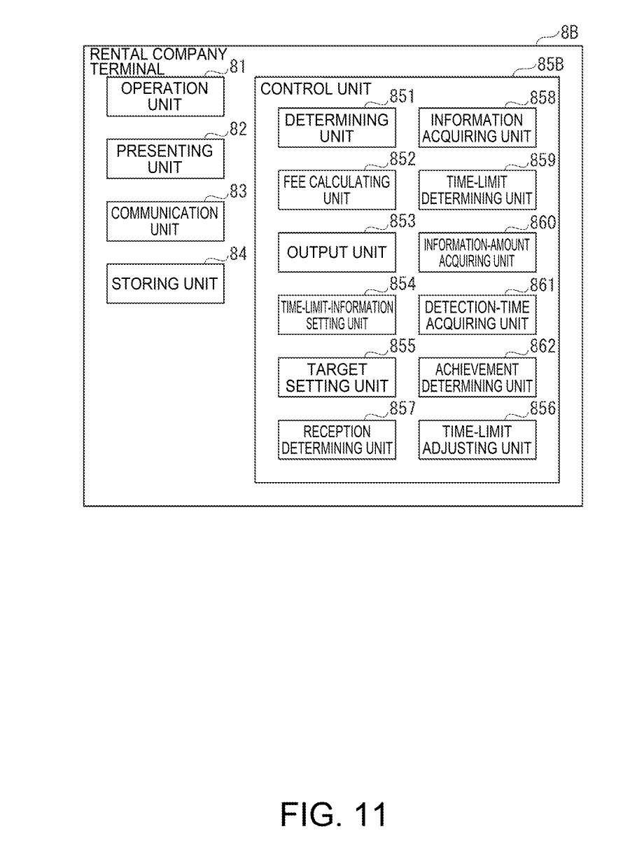

The biological information detecting system according to this embodiment includes a biological information detecting apparatus 2B and a rental company terminal 8B (see FIG. 11). The biological information detecting system functions in the same manner as the biological information detecting system explained in the second embodiment.

The detecting apparatus 2B includes components and functions same as the components and the functions of the detecting apparatus 2A except that the detecting apparatus 2B includes a control unit 27B instead of the control unit 27A. That is, in the detecting apparatus 2B as well, the notification control processing is executed.

The control unit 27B functions in the same manner as the control unit 27A. The control unit 27B includes, as shown in FIG. 10, the detection control unit 271, the notification control unit 272, the communication control unit 273, the clocking unit 274, the information acquiring unit 275, a time determining unit 285, an information transmitting unit 286, a reception determining unit 287, and a time-limit updating unit 284.

The time determining unit 285 determines whether one day (twenty-four hours) has elapsed after information is transmitted to the company terminal 8B by the information transmitting unit 286. Note that the time determining unit 285 may determine whether time of the present date and time clocked by the clocking unit 274 has reached predetermined time. In this case, examples of the predetermined time include midnight.

When the time determining unit 285 determines that one day has elapsed, the information transmitting unit 286 transmits, with the communication unit 25, to the company terminal 8B, transmission information including biological information and body motion information for one day in the past stored in the storing unit 26 and time information indicating time when the biological information and the body motion information are detected.

The reception determining unit 287 determines whether time limit information after adjustment is received from the company terminal 8B. When the reception determining unit 287 determines that the time limit information after the adjustment is received, the time-limit updating unit 284 updates, on the basis of the time limit information after the adjustment, the time limit information stored in the storing unit 26.

FIG. 11 is a block diagram showing the configuration of the company terminal 8B.

As shown in FIG. 11, the company terminal 8B includes components and functions same as the components and the functions of the company terminal 8A except that the company terminal 8B includes a control unit 85B instead of the control unit 85A. The control unit 85B includes components and functions same as the components and the functions of the control unit 85A except that the control unit 85B further includes a reception determining unit 857, an information acquiring unit 858, a time-limit determining unit 859, an information-amount acquiring unit 860, a detection-time acquiring unit 861, and an achievement determining unit 862.

The reception determining unit 857 determines whether the transmission information is received from the detecting apparatus 2B.

When it is determined that the transmission information is received from the detecting apparatus 2B, the information acquiring unit 858 acquires biological information, the body motion information, and time information from the transmission information and causes the storing unit 84 to store these kinds of information in association with identification information of the detecting apparatus 2B.

Like the time-limit determining unit 277, the time-limit determining unit 859 determines whether less than one day is left until a return due date indicated by the time limit information of the detecting apparatus 2B that transmits the transmission information.

The information-amount acquiring unit 860 functions when the time-limit determining unit 859 determines that less than one day is left until the return due date. Like the information-amount acquiring unit 278, the information-amount acquiring unit 860 acquires information amounts of the respective biological information and body motion information stored in the storing unit 84 in association with the identification information of the detecting apparatus 2B. In this case, the information-amount acquiring unit 860 acquires information amounts of respective biological information and body motion information acquired and stored after a most recent date of rent of the detecting apparatus 2B rather than acquiring information amounts of the respective kinds of information for one day in the past.

The detection-time acquiring unit 861 acquires detection times of the respective biological information and body motion information on the basis of the time information included in the transmission information. In this case, like the information-amount acquiring unit 860, the detection-time acquiring unit 861 acquires detection times of the respective biological information and body motion information acquired and stored after the most recent date of rent of the detecting apparatus 2B. Note that, in this embodiment, it is determined on the basis of the information amounts of the respective biological information and body motion information acquired by the information-amount acquiring unit 860 whether the time limit information is adjusted. Therefore, the detection-time acquiring unit 861 does not have to be provided. However, when it is determined on the basis of the detection times of the respective biological information and body motion information whether the time limit information is adjusted, the detection-time acquiring unit 861 is necessary.

Like the achievement determining unit 281, the achievement determining unit 862 determines, on the basis of the information amounts of the respective biological information and body motion information acquired by the information-amount acquiring unit 860, according to a detection state up to the present of the detecting apparatus 2B, whether the respective target values set by the target setting unit 855 are achieved.

In this embodiment, the target setting unit 855 sets target values of information amounts of respective biological information and body motion information detected by the detecting apparatus 2B. The target values are set as appropriate according to a rental period of the detecting apparatus 2B indicated by the time limit information. The target setting unit 855 divides the target values by the rental period and sets target values for each day.

For example, if the rental period is ten days, the target setting unit 855 sets two days among the ten days as reserved days and sets information amounts that can be acquired in eight days as target values in the rental period. The target setting unit 855 sets target values of the first day to values of 10% of total target values. Thereafter, as a day elapses, the target setting unit 855 increases target values of the day by values of 10% of the total target values and sets target values of days such that target values of a return due date is 100% of the total target values.

When information amounts of respective acquired biological information and body motion information exceed target values corresponding to the number of days elapsed from a date of rent, the achievement determining unit 862 determines that the targets are achieved.

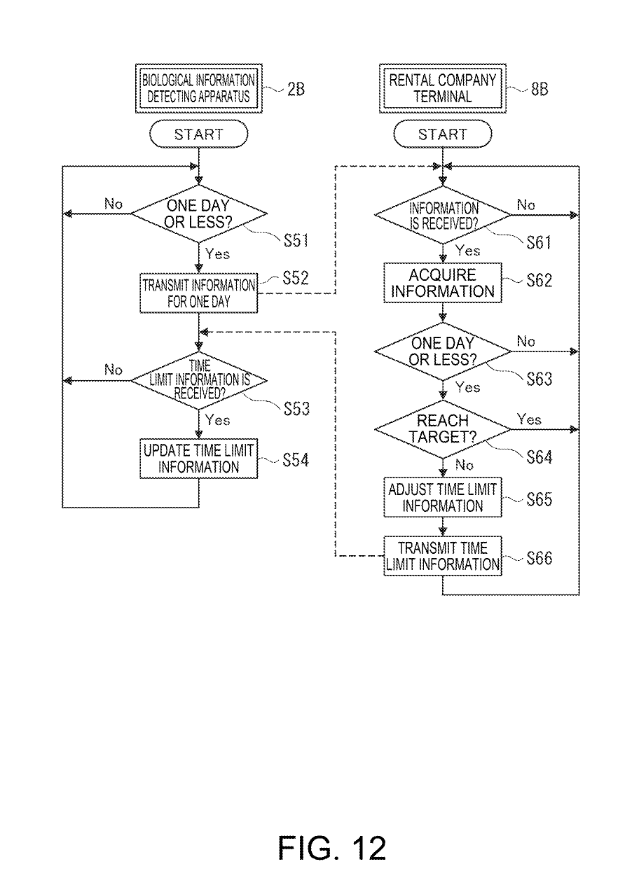

FIG. 12 is a flowchart for explaining update processing for time limit information executed in the biological information detecting system according to this embodiment.

In the biological information detecting system according to this embodiment, the detecting apparatus 2B, which is rent out in a state in which the time limit information and the target values are set, executes update processing explained below and performs update of the time limit information according to necessity in conjunction with the company terminal 8A.

In the update processing, as shown in FIG. 12, first, the time determining unit 285 of the control unit 27B configuring the detecting apparatus 2B determines whether one day has elapsed after biological information and the like are transmitted last time (S51). Note that, as explained above, the time determining unit 285 may perform the processing after determining whether the present time has reached the predetermined time. The determination processing in step S51 is repeatedly executed at a predetermined cycle (e.g., one day).

When it is determined in the determination processing in step S51 that one day has not elapsed (the present time has not reached the predetermined time), the control unit 27B returns the processing to step S51 and repeatedly executes the determination processing in step S51.

When it is determined in the determination processing in step S51 that one day has elapsed, the information transmitting unit 286 transmits transmission information including biological information and body motion information for one day in the past stored in the storing unit 26 and the time information to the company terminal 8B (step S52).

Thereafter, the control unit 27B shifts the processing to step S53.

In the company terminal 8B, the reception determining unit 857 of the control unit 85B determines whether the transmission information is received from the detecting apparatus 2B (step S61). When it is determined in this determination processing that the transmission information is not received, the control unit 85B shifts the processing to step S61 and repeatedly executes the determination processing in step S61.

On the other hand, when it is determined that the transmission information is received, the information acquiring unit 858 acquires the biological information and the body motion information for one day in the past and the time information included in the transmission information and causes the storing unit 84 to store these kinds of information (step S62).

Subsequently, the time-limit determining unit 859 determines whether less than one day is left until the return due date indicated by the time limit information of the detecting apparatus 2B that transmits the transmission information (step S63). When it is determined in this determination processing that days left until the return due date are not less than one day (i.e., one or more days are left until the return due date), the control unit 85B returns the processing to step S61.

On the other hand, when it is determined that less than one day is left until the return due date, the achievement determining unit 862 determines, on the basis of information amounts of respective biological information and body motion information acquired by the information-amount acquiring unit 860 and respective target values set by the target setting unit 855, whether detection states of the biological information and the body motion information are about to reach targets (step S64).

When it is determined in the determination processing in step S64 that the detection states are about to reach the targets, the control unit 85B returns the processing to step S61.

On the other hand, when it is determined in the determination processing in step S64 that the detection states are not about to reach the targets, as explained above, the time-limit adjusting unit 856 adjusts the time limit information of the detecting apparatus 2B (step S65) and transmits the time limit information after the adjustment to the detecting apparatus 2B (step S66). In this case, the control unit 85B transmits degrees of achievement of the information amounts of the respective biological information and body motion information with respect to the target values (degrees of achievement with respect to total target values) together with the time limit information after the adjustment.

After step S66, the control unit 85B returns the processing to step S61.

In the detecting apparatus 2B, after step S52, the reception determining unit 287 determines whether the time limit information after the adjustment is received from the company terminal 8B (step S53).

When it is determined that the time limit information after the adjustment is not received, determining that the time limit adjustment is not performed, the control unit 27B returns the processing to step S51.

On the other hand, when it is determined that the time limit information after the adjustment is received, the time-limit updating unit 284 updates, on the basis of the time limit information, the time limit information stored in the storing unit 26 (step S54).

After step S54, the control unit 27B returns the processing to step S51.

Note that, when the degrees of achievement are received together with the time limit information after the adjustment, the notification control unit 272 causes the display unit 241 to display the degrees of achievement.

### Effects of the Third Embodiment

With the biological information detecting system according to this embodiment explained above, it is possible to attain effects same as the effects of the biological information detecting system in the second embodiment. Besides, it is possible to attain effects explained below.

In this embodiment, in the company terminal 8B, target values for one day are set and it is possible to determine whether the targets are achieved. Therefore, it is possible to adjust the time limit information for every one day. Consequently, it is possible to surely detect biological information and body motion information within a time limit set in the company terminal 8B.

Since the detecting apparatus 2B does not adjust the time limit information, a rental company, which uses the company terminal 8B, can surely and appropriately manage the present time limit information of the detecting apparatus 2B. Further, the detecting apparatus 2B does not need to include the comparing unit 276, the time-limit determining unit 277, the information-amount acquiring unit 278, the detection-time clocking unit 279, the target setting unit 280, and the achievement determining unit 281 included in the detecting apparatuses 2 and 2A. Therefore, compared with the detecting apparatuses 2 and 2A, it is possible to attain a reduction in the costs, a reduction in the weight, and a reduction in the size of the detecting apparatus 2B.

When the time limit information and the degrees of achievement are received from the company terminal 8B, the notification control unit 272 of the detecting apparatus 2B causes the display unit 241 to display the degrees of achievement. Therefore, a user can simultaneously recognize the degrees of achievement and the biological information. Consequently, it is possible to make the user aware of the degrees of achievement and urge the user to take action for improving the degrees of achievement. Therefore, it is possible to reduce likelihood of adjustment of the time limit information.

### Fourth Embodiment

A fourth embodiment of the invention is explained below.

A biological information detecting system according to this embodiment is different from the biological information detecting systems in the first to third embodiments in that the biological information detecting system includes a data center that mediates a biological information detecting apparatus and a rental company terminal, stores information detected by the biological information detecting apparatus, and transmits an analysis result of the information and an accounting processing result to the rental company terminal. Note that, in the following explanation, portions the same as or substantially the same as the portions explained above are denoted by the same reference numerals and signs and explanation of the portions is omitted.

### Configuration of the Biological Information Detecting System

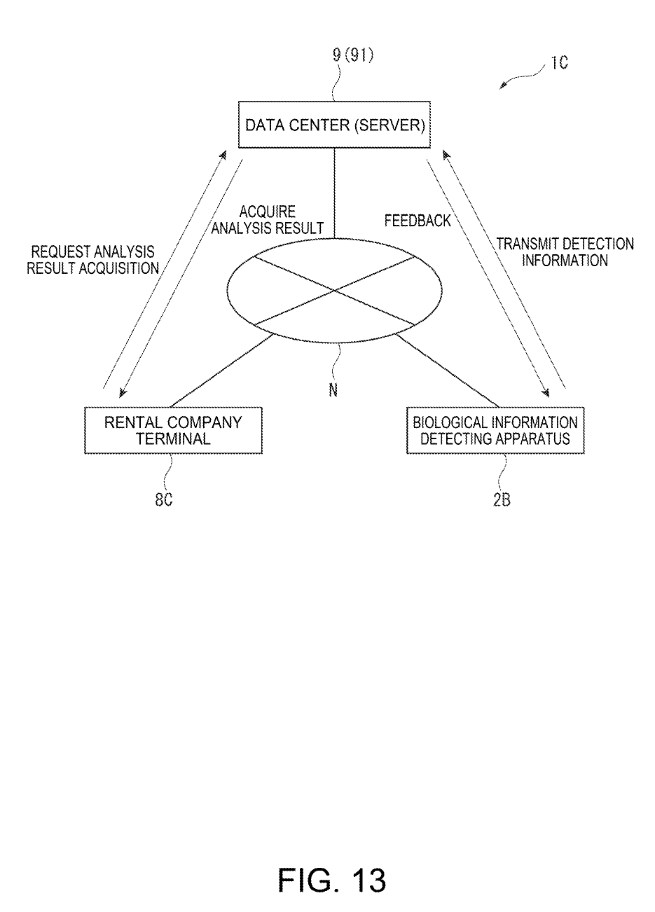

FIG. 13 is a schematic diagram showing a biological information detecting system 1C according to the fourth embodiment of the invention.

The biological information detecting system 1C in this embodiment includes, as shown in FIG. 13, the biological information detecting apparatus 2B, a rental company terminal 8C, and a data center 9 capable of communicating with one another via the network N. The biological information detecting system 1C includes functions same as the functions of the biological information detecting system.

In this embodiment, the data center 9 is set as a transmission and reception destination of various kinds of information of the biological information detecting apparatus 2B. Therefore, the transmission information (information including biological information, detection information, and time information) is transmitted from the detecting apparatus 2B to the data center 9. The time limit information after the adjustment and the degrees of achievement are transmitted from the data center 9 to the biological information detecting apparatus 2B.

The data center 9 includes a server 91 equivalent to the managing apparatus according to the invention. The server 91 includes components and functions same as the components and the functions of the rental company terminal 8B.

Specifically, after acquiring identification information and time limit information of the detecting apparatus 2B from the company terminal 8C, the server 91 communicates with the detecting apparatus 2B and executes the update processing explained in the third embodiment in conjunction with the detecting apparatus 2B. Besides, the server 91 calculates degrees of achievement with respect to target values and transmits the degrees of achievement to the detecting apparatus 2B.

The server 91 executes the accounting processing according to a request from the company terminal 8C and transmits a processing result to the company terminal 8C. Besides, the server 91 transmits an analysis result of the acquired biological information and body motion information to the company terminal 8C.

The rental company terminal 8C includes components same as the components of the company terminal 8A. However, since the server 91 of the data center 9 executes the update processing and the accounting processing, the company terminal 8C does not include the fee calculating unit 852 and the time-limit adjusting unit 856 included in the company terminal 8A. However, in the biological information detecting apparatus 2B, time limit information and target values are set when the biological information detecting apparatus 2B is rent out. Therefore, the company terminal 8C includes the time-limit-information setting unit 854 and the target setting unit 855. However, as explained above, the biological information detecting apparatus 2B may include the target setting unit 855.

On the other hand, although not shown in the figure, the company terminal 8C includes a request-information transmitting unit that transmits request information for requesting the server 91 to transmit a processing result of the accounting processing and request information for requesting a processing result of analysis processing of biological information and body motion information by the server 91. Besides, the company terminal 8C includes a processing-result acquiring unit that acquires these processing results. The processing result of the accounting processing and the processing result of the analysis processing are presented in the presenting unit 82.

### Effects of the Fourth Embodiment

With the biological information detecting system. 1C according to this embodiment explained above, it is possible to attain effects same as the effects of the biological information detecting system according to the third embodiment. Besides, it is possible to attain effects explained below.

In this embodiment, since the data center 9 (the server 91) is provided. A part or the entire processing executed in the company terminal 8B in the third embodiment can be executed in the server 91. Consequently, it is possible to save labor of the rental company.

Since the data center 9 (the server 91) executes the various kinds of processing, the company terminal 8C does not need to include the units of the control unit 85. Therefore, compared with the company terminals 8, 8A, and 8B, it is possible to attain a reduction in the costs, a reduction in the weight, and a reduction in the size of the company terminal 8C.

### Fifth Embodiment

A biological information detecting apparatus according to a fifth embodiment of the invention is explained.

The biological information detecting apparatus according to this embodiment includes a configuration same as the configuration of the biological information detecting system 1 according to the first embodiment. In the detecting apparatus 2 of the biological information detecting system 1, when the update processing is performed, the achievement determining unit 281 determines whether respective present information amounts of e detected biological information and body motion information (present information amounts of biological information and body motion information stored in the storing unit 26) are about to reach target values set in advance by the target setting unit 280. When it is determined that the present information amounts do not reach the target values, the time-limit adjusting unit 282 adjusts and updates time-limit information stored in the storing unit 26. On the other hand, in this embodiment, time limit information is updated according to a processing procedure different from the update processing in the first embodiment. That is, the configuration of a control unit of the biological information detecting apparatus is different from the configuration of the control unit of the detecting apparatus 2. The biological information detecting system 1 and a biological information detecting system according to this embodiment are different in these points. Note that, in the following explanation, portions the same as or substantially the same as the portions explained above are denoted by the same reference numerals and signs and explanation of the portions is omitted.

### Configuration of the Control Unit

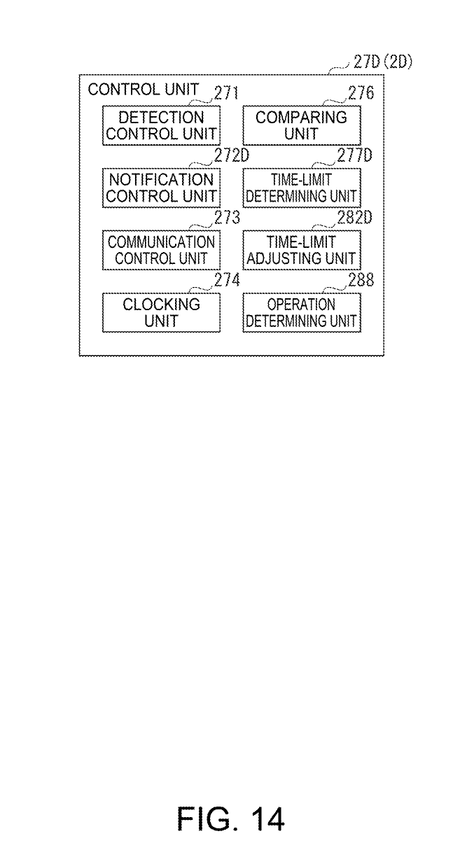

FIG. 14 is a block diagram showing the configuration of a control unit 27D included in a biological information detecting apparatus 2D configuring the biological information detecting system according to this embodiment.

The biological information detecting system according to this embodiment includes the biological information detecting apparatus 2D (hereinafter sometimes referred to as detecting apparatus 2D) and the rental company terminal 8 (see FIG. 1). The biological information detecting system functions in substantially the same manner as the biological information detecting system 1 explained in the first embodiment.

The detecting apparatus 2D includes components and functions same as the components and the functions of the detecting apparatus 2 except that the detecting apparatus 2D includes the control unit 27D instead of the control unit 27. That is, the notification control processing is executed in the detecting apparatus 2D.

The control unit 27D functions in the same manner as the control unit 27. The control unit 27D includes, as shown in FIG. 14, the detection control unit 271, a notification control unit 272D, the communication control unit 273, the clocking unit 274, the comparing unit 276, a time-limit determining unit 277D, a time-limit adjusting unit 282D, and an operation determining unit 288.

The notification control unit 272D includes functions same as the functions of the notification control unit 272. Besides, when the time-limit determining unit 277D determines that a return due date has expired, the notification control unit 272D controls the display unit 241 and regulates display of biological information and comparison information displayed on the display unit 241. When extension operation for the return due date is executed, the notification control unit 272D controls the display unit 241 to release the display regulation of the biological information and the comparison information.

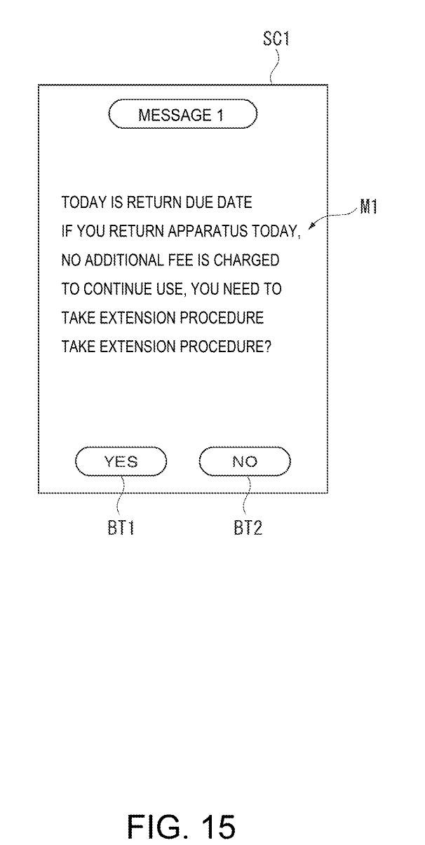

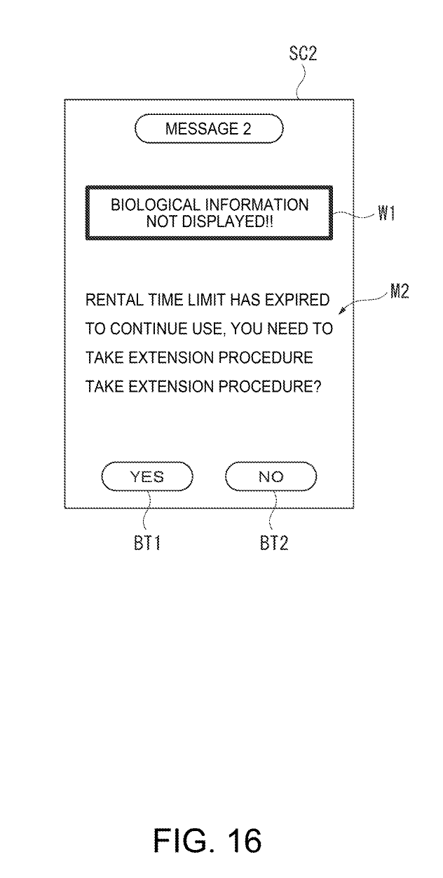

The notification control unit 272D includes a function of causing the display unit 241 to display a first message screen SC1 and a second message screen SC2 (see FIGS. 15 and 16) stored in advance in the storing unit 26.

FIG. 15 is a diagram showing the first message screen SC1 stored in advance in the storing unit 26.

On the first message screen SC1, as shown in FIG. 15, a message M1 of an interactive form for informing the user that today is a return due date of the detecting apparatus 2D and causing the user to select whether an extension procedure (an extended use procedure) for the detecting apparatus 2D is performed is displayed.

Buttons BT1 and BT2 for causing the user to select whether the extension procedure for the detecting apparatus 2D is performed are displayed below the message M1 on the first message screen SC1. Consequently, by pressing one of the button BT1 (a YES button) and the button BT2 (a NO button), the user can select whether the extension procedure for the detecting apparatus 2D is executed.

FIG. 16 is the second message screen SC2 stored in advance in the storing unit 26.

On the second message screen SC2, as shown in FIG. 16, a warning W1 indicating that biological information is not displayed on the display unit 241 is displayed. On the second message screen SC2, a message M2 of an interactive form for informing the user that a return due date of the detecting apparatus 2D has expired and causing the user to select whether an extension procedure for the detecting apparatus 2D is performed.

Further, as on the first message screen SC1, the buttons BT1 and BT2 are displayed below the message M2 on the second message screen SC2. Consequently, as on the first message screen SC1, by pressing one of the button BT1 (the YES button) and the button BT2 (the NO button), the user can select whether the extension procedure for the detecting apparatus 2D is executed. That is, the second message screen SC2 is equivalent to the selection screen according to the invention.

Note that, in this embodiment, when the button BT1 is pressed, the notification control unit 272D displays, although not shown in the figure, a setting screen for setting an extended use time limit of the detecting apparatus 2D. The user can set a desired extended use time limit (e.g., three days).

Referring back to FIG. 14, the time-limit determining unit 277D includes functions same as the functions of the time-limit determining unit 277. Besides, the time-limit determining unit 277D include a function of determining whether the present time clocked by the clocking unit 274 is the return due date of the detecting apparatus 2D and determining whether the return due date has expired.

When it is determined that the button BT1 displayed on the first and second message screens SC1 and SC2 is pressed, the time-limit adjusting unit 282D adjusts the time limit information stored in the storing unit 26 on the basis of the extended use time limit set on the setting screen.

The operation determining unit 288 determines whether operation of the operation unit 21 is performed by the user when display of biological information on the display unit 241 is regulated by the notification control unit 272D.

### Update Control Processing

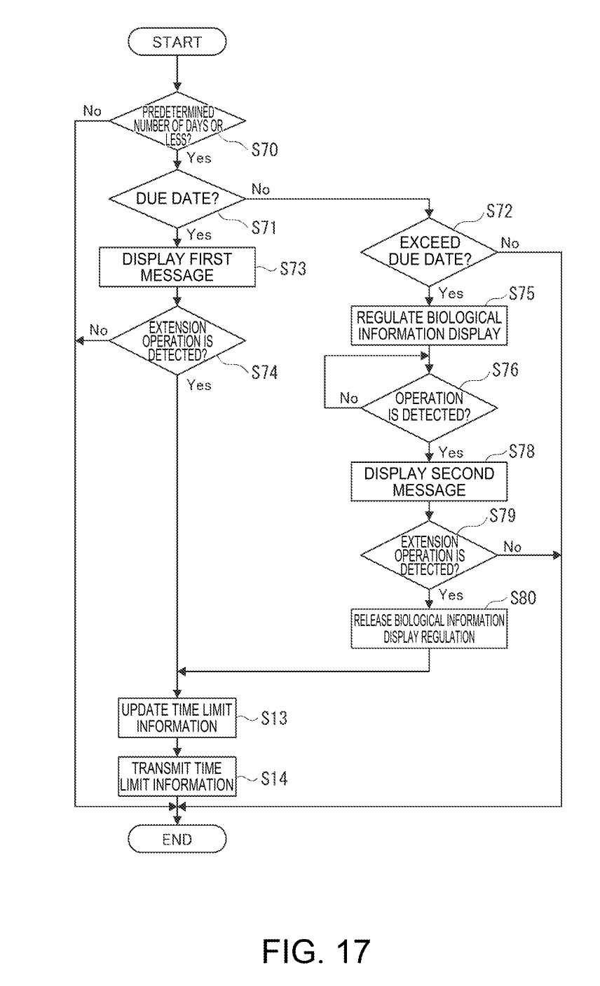

FIG. 17 is a flowchart for explaining update processing for time limit information in this embodiment.

The control unit 27D executes update processing explained below on the basis of a computer program stored in the storing unit 26. The update processing is processing for updating the time limit information on the basis of the return time limit (time limit information) of the detecting apparatus 2D when it is necessary to update the time limit information.

In the update processing, as shown in FIG. 17, first, the comparing unit 276 compares a date of the present date and time clocked by the clocking unit 274 and the return due date indicated by the time limit information stored in the storing unit 26. The time-limit determining unit 277D determines, on the basis of a comparison result by the comparing unit 276, whether the number of days to the return due date of the detecting apparatus 2D is a predetermined number of days or less (step S70). Note that, when the number of days to the return due date is the predetermined number of days or less or when the return due date has expired, the time-limit determining unit 277D determines that the number of days is the predetermined number of days or less.

When it is determined in the determination processing in step S70 that the number of days to the return due date is more than the predetermined number of days, the control unit 27D ends the update processing.

On the other hand, when it is determined in the determination processing in step S70 that the number of days to the return due date is the predetermined number of days or less, the time-limit determining unit 277D determines whether a day to which the present date and time belongs (today) is the return due date (step S71).

When it is determined in the determination processing in step S71 that today is not the return due date, the time-limit determining unit 277D determines whether the present date and time exceeds the return due date (step S72). Note that step S72 is equivalent to the determining whether the return time limit has expired according to the invention. When it is determined in the determination processing in step S72 that the present date and time does not exceed the return due date, in the same manner as when it is determined in step S70 that the number of days is more than the predetermined number of days, the control unit 27D ends the update processing.

On the other hand, when it is determined in the determination processing in step S72 that today is the return due date, the notification control unit 272D causes the display unit 241 to display the first message screen SC 1 (step S73). Note that step S73 is equivalent to the causing the user to select whether the return time limit is extended according to the invention.

The notification control unit 272D determines whether extension operation is performed by the user, that is, whether the button BT1 is pressed (step S74). When it is determined in the determination processing in step S74 that the extension operation is performed by the user, the notification control unit 272D causes the display unit 241 to display a setting screen for setting an extended use time limit of the detecting apparatus 2D. The user can set a desired extended use time limit (e.g., three days). When the desired extended use time limit is set, the processing shifts to the next processing.

On the other hand, when it is determined in the determination processing in step S74 that the extension operation is not performed by the user (the button BT1 is not pressed by the user), that is, when the button BT2 is pressed, the control unit 27D ends the update processing.

On the other hand, when it is determined in the determination processing in step S72 that the present date and time exceeds the due date, the notification control unit 272D regulates display of biological information displayed on the display unit 241 (step S75). Consequently, even if the user views the display unit 241, the user cannot recognize biological information of the user. Note that step S75 is equivalent to the regulating the display unit from being caused to display the biological information according to the invention.

In a state in which the display of biological information on the display unit 241 is regulated by the notification control unit 272D, the operation determining unit 288 determines whether operation of the operation unit 21 is executed by the user (step S76). For example, when the user recognizes that biological information is not displayed on the display unit 241, the user is highly likely to execute some operation on the operation unit 21. That is, the operation determining unit 288 determines that operation is performed irrespective a type of the operation as long as the operation is operation on the operation unit 21.

When the operation of the operation unit 21 is detected by the determination processing in step S76, the notification control unit 272D causes the display unit 241 to display the second message screen SC2 (step S78).

The notification control unit 272D determines whether extension operation is performed by the user, that is, whether the button BT1 is pressed (step S79). Note that, when it is determined in the determination processing in step S79 that the extension operation is performed by the user, in the same manner as when it is determined in step S74 that the button BT1 is pressed, the notification control unit 272D causes the display unit 241 to display a setting screen for setting an extended use time limit of the detecting apparatus 2D.

Further, when it is determined in the determination processing in step S79 that the extension operation is performed by the user, the notification control unit 272D releases the display regulation of biological information on the display unit 241 (step S80). The processing shifts to the next processing. Note that step S80 is equivalent to the causing the display unit to display the biological information again according to the invention.

On the other hand, when it is determined in the determination processing in step S79 that the extension operation is not performed by the user (the button BT1 is not pressed by the user), that is, when the button BT2 is pressed, the control unit 27D ends the update processing.

The time-limit adjusting unit 282D adjusts and updates the time limit information stored in the storing unit 26 to time limit information based on the extended use time limit set by the user on the setting screen (step S13).

Thereafter, the communication control unit 273 transmits the time limit information after the update to the company terminal 8 via the communication unit 25 (step S14). After step S14, the control unit 27D ends the update processing.

### Effects of the Fifth Embodiment

With the biological information detecting system according to this embodiment explained above, it is possible to attain effects same as the effects of the biological information detecting systems according to the first to fourth embodiments. Besides, it is possible to attain effects explained below.

The second message screen SC2 functioning as the selection screen for selecting whether the return time limit is extended is displayed on the display unit 241. Therefore, it is possible to easily cause the user to recognize that the return time limit of the biological information detecting apparatus 2D has expired. By causing the user to recognize the second message screen SC2, it is possible to urge the user to extend the return time limit of the biological information detecting apparatus 2D. Therefore, it is possible to surely prevent the biological information detecting apparatus 2D from being returned before biological information of an amount necessary for an analysis is detected.

For example, in the case of a biological information detecting apparatus in which detection of biological information is stopped when it is determined that the present time exceeds the return time limit (e.g., a biological information detecting apparatus in a sixth embodiment explained below), when a return time limit of the biological information detecting apparatus is extended, biological information of a user cannot be detected from the stop until the return time limit of the biological information detecting apparatus is extended. On the other hand, in this embodiment, detected biological information of the user is not displayed on the display unit 241 but is continuously detected. Therefore, it is more likely that the number of extended days of the return time limit can be reduced compared with the biological information detecting apparatus in the sixth embodiment. Therefore, it is possible to increase likelihood that the biological information detecting apparatus is returned early after biological information of an amount necessary for an analysis is detected.

### Sixth Embodiment

A biological information detecting apparatus according to a sixth embodiment of the invention is explained.

The biological information detecting apparatus according to this embodiment includes a configuration same as the configuration of the biological information detecting system according to the fifth embodiment. In this embodiment, time limit information is updated according to a processing procedure partially different from the update processing in the fifth embodiment. That is, the configuration of a control unit of the biological information detecting apparatus in this embodiment is different from the configuration of the control unit of the detecting apparatus 2D. The biological information detecting system and a biological information detecting system according to this embodiment are different in these points. Note that, in the following explanation, portions the same as or substantially the same as the portions explained above are denoted by the same reference numerals and signs and explanation of the portions is omitted.

### Configuration of the Control Unit

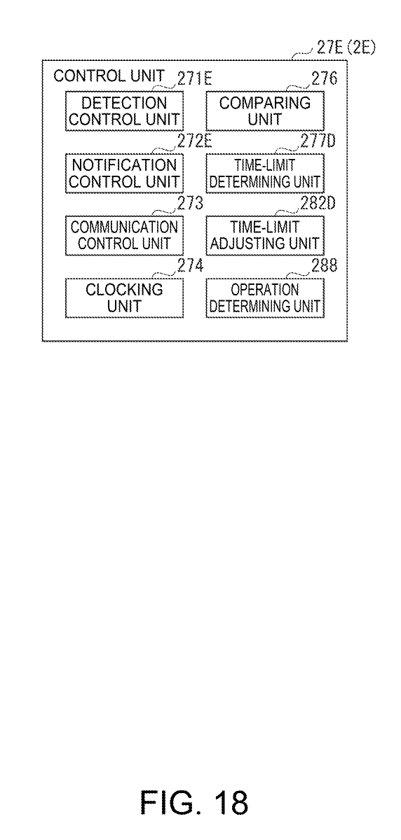

FIG. 18 is a block diagram showing the configuration of a control unit 27E included in a biological information detecting apparatus 2E configuring the biological information detecting system according to this embodiment.

The biological information detecting system according to this embodiment includes the biological information detecting apparatus 2E (hereinafter sometimes referred to as detecting apparatus 2E) and the rental company terminal 8 (see FIG. 1) and functions in the same manner as the biological information detecting system. 1 explained in the first and fifth embodiments.

The detecting apparatus 2E includes components and functions same as the components and the functions of the detecting apparatus 2D except that the detecting apparatus 2E includes the control unit 27E instead of the control unit 27D. That is, the notification control processing is executed in the detecting device 2E.

The control unit 27E functions in the same manner as the control unit 27D. The control unit 27E includes, as shown in FIG. 18, a detection control unit 271E, a notification control unit 272E, the communication control unit 273, the clocking unit 274, the comparing unit 276, a time-limit determining unit 277D, a time-limit adjusting unit 282D, and the operation determining unit 288.

The detection control unit 271E controls the operation of the detecting unit 22 and causes the storing unit 26 to store a detection result by the detecting unit 22 together with the present time clocked by the clocking unit 274. Besides, when it is determined that the present time exceeds a return time limit of the detecting apparatus 2E, the detection control unit 271E causes the detecting unit 22 to stop the detection of biological information by the detecting unit 22. When a use time limit of the detecting apparatus 2E is extended by a user, the detection control unit 271E causes the detecting unit 22 to resume the detection of biological information.

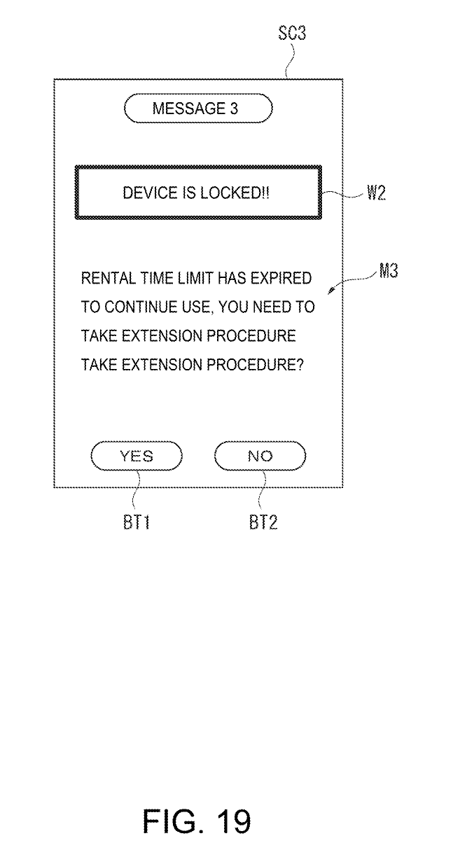

The notification control unit 272E includes functions same as the functions of the notification control unit 272D. The notification control unit 272E includes a function of causing the display unit 241 to display the first message screen SC1 and a third message screen SC3 (see FIGS. 15 and 19) stored in advance in the storing unit 26.

FIG. 19 is a third message screen SC3 stored in advance in the storing unit 26.

On the third message screen SC3, as shown in FIG. 19, a warning W2 indicating that biological information is not detected is displayed. On the third message screen SC3, a message M3 of an interactive form for informing the user that a return due date of the detecting apparatus 2E has expired and causing the user to select whether an extension procedure for the detecting apparatus 2E is performed is displayed.

Further, as on the first and second message screens SC1 and SC2, the buttons BT1 and BT2 are displayed below the message M3 on the third message screen SC3. Consequently, as on the first and second message screens SC1 and SC2, by pressing one of the button BT1 (the YES button) and the button BT2 (the NO button), the user can select whether the extension procedure for the detecting apparatus 2E is executed. That is, the third message screen SC3 is equivalent to the selection screen according to the invention.

Note that, in this embodiment as well, when the button BT1 is pressed, the notification control unit 272E displays, although not shown in the figure, a setting screen for setting an extended use time limit of the detecting apparatus 2E. The user can set a desired extended use time limit (e.g., three days).

### Update Control Processing

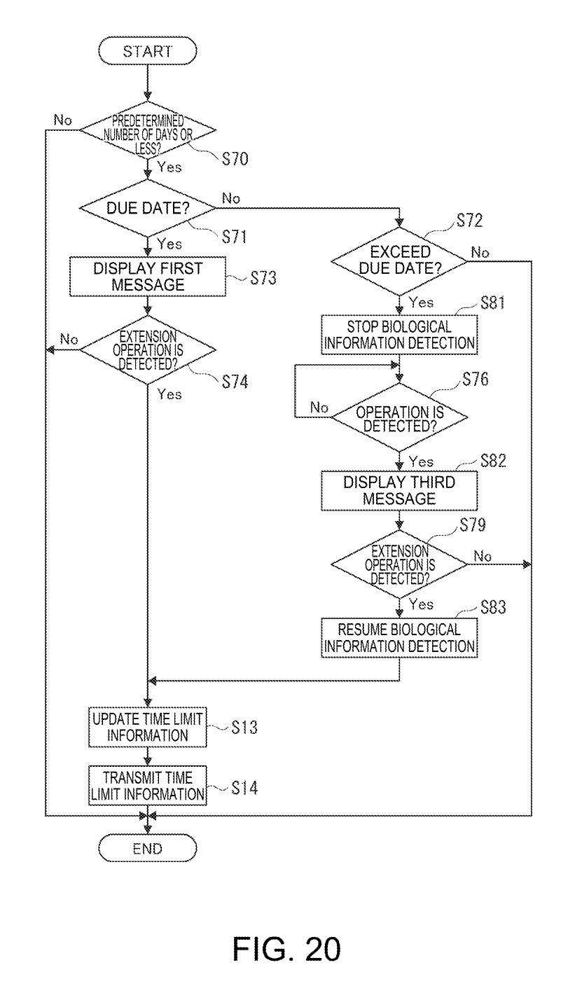

FIG. 20 is a flowchart for explaining update processing in this embodiment.

The control unit 27E executes update processing explained below on the basis of a computer program stored in the storing unit 26. The update processing is processing for updating time limit information on the basis of a return time limit (time limit information) of the detecting apparatus 2E when it is necessary to update the time limit information.

Note that, in the update processing in this embodiment, since only processing after the determination processing in step S72 in the fifth embodiment is different, only the different portion is explained.

When it is determined in the determination processing in step S72 that the present date and time does not exceed the return due date, in the same manner as when it is determined in step S70 that the number of days is more than the predetermined number of days, the control unit 27D ends the update processing.

On the other hand, when it is determined in the determination processing in step S72 that today is the return due date, the detection control unit 271E controls the detecting unit 22 to stop the detection of biological information (step S81). Note that step S81 is equivalent to the stopping the detection of biological information according to the invention.

In a state in which the detection of biological information of the detecting apparatus 2E is stopped by the notification control unit 272D, the operation determining unit 288 determines whether the operation of the operation unit 21 is executed by the user (step S76).

When the operation of the operation unit 21 is detected in the determination processing in step S76, the notification control unit 272D causes the display unit 241 to display the third message screen SC3 (step S82).

The notification control unit 272E determines whether extension operation is performed by the user, that is, the button BT1 is pressed (step S79). Note that, when it is determined in the determination processing in step S79 that the extension operation is performed by the user, the notification control unit 272E causes the display unit 241 to display a setting screen for setting an extended use time limit of the detecting apparatus 2E.

Further, when it is determined in the determination processing in step S79 that the extension operation is performed by the user, the notification control unit 272E causes the detecting unit 22 to resume the detection of biological information by the detecting unit 22 (step S83). The processing shifts to the next processing. Note that step S83 is equivalent to the causing the biological-information detecting unit to resume the detection of biological information according to the invention.

On the other hand, when it is determined in the determination processing in step S79 that the extension operation is not performed by the user (the button BT1 is not pressed by the user), that is, when the button BT2 is pressed, the control unit 27E ends the update processing.

The time-limit adjusting unit 282D adjusts and updates the time limit information stored in the storing unit 26 to time limit information based on the extended use time limit set by the user on the setting screen (step S13).

Thereafter, the communication control unit 273 transmits the time limit information after the update to the company terminal 8 via the communication unit 25 (step S14). After step S14, the control unit 27E ends the update processing.

### Effects of the Sixth Embodiment

With the biological information detecting system according to this embodiment explained above, it is possible to attain effects same as the effects of the biological information detecting system according to the fifth embodiment. Besides, it is possible to attain effects explained below.

The detection of biological information is stopped when it is determined that the return time limit of the biological information detecting apparatus 2E has expired. The detection of biological information is resumed when the user extends the return time limit of the biological information detecting apparatus 2E. Therefore, when the user does not extend the return time limit, it is possible to prevent biological information of the user from being detected. Consequently, for example, when the biological information detecting apparatus 2E is returned while the detection of biological information is stopped, it is possible to prevent unnecessary measurement data from being accumulated. Therefore, it is possible to reduce time of a data analysis of the biological information or the like of the user. When the return time limit of the biological information detecting apparatus 2E is not extended, since the biological information is not detected, it is possible to increase likelihood that the user quickly returns the biological information detecting apparatus 2E. Therefore, when the user does not extend the return time limit of the biological information detecting apparatus 2E, it is possible to increase likelihood that the biological information detecting apparatus 2E is returned. Alternatively, when it is necessary to extend the return time limit, it is possible to urge the user to perform processing for extending the return time limit.

### Modifications of the Embodiments

The invention is not limited to the embodiments. Modifications, improvements, and the like within a range in which the object of the invention can be attained are included in the invention.

In the embodiments, the display unit 241 is caused to display a detection result by the detecting unit 22 and the comparison result from three days before the return due date. However, the invention is not limited to this. That is, the comparison result may be always displayed together with the detection result. Rather than displaying the comparison result from three days before the return due date, the number of remaining days to the return due date in displaying the comparison result can be changed as appropriate to, for example, two days.

In the fourth embodiment, the data center 9 executes the accounting processing. However, the invention is not limited to this. For example, as in the first to third embodiments, the company terminal 8B may execute the accounting processing.

In the embodiments, when it is determined that a date of return is later than a return due date, the fee calculating unit calculates an additional fee according to adjusted time limit information, that is, the number of days extended from the original return due date. However, the invention is not limited to this. For example, the determining unit may determine whether the time limit information is extended a plurality of times. Consequently, only when the time limit information is extended a plurality of times, it is possible to charge the user a fee added with the additional fee.

The accounting processing is executed in the embodiments. However, the invention is not limited to this. The accounting processing does not have to be executed in the embodiments.

In the embodiments, time limit information is the last day (the return due date) of the return time limit set by the rental company. However, the invention is not limited to this. For example, the time limit information may be a use time limit of the detecting apparatuses 2, 2A, and 2B (a detection time limit of biological information and body motion information). Consequently, the number of remaining days to a use due date of the detecting apparatuses 2, 2A, and 2B is notified as a comparison result. Therefore, the user can easily recognize the use time limit and the number of remaining days to the use due date of the detecting apparatuses 2, 2A, and 2B.

In the embodiments, the detecting apparatus 2, the company terminals 8A and 8B, and the data center 9 adjust the time limit information with the time-limit adjusting unit. However, the invention is not limited to this. For example, the time limit information does not have to be adjusted.

As the adjustment of the time limit information, in principle, adjustment for extending the time limit information is executed. However, the invention is not limited to this. For example, when data amounts or the like of biological information and body motion information are accumulated exceeding target values, adjustment for reducing the time limit information (a date of return) may be executed.

In the embodiments, the target setting units 280 and 855 set target values of information amounts of respective biological information and body motion information. As a modification of the embodiments, the target setting units 280 and 855 may set target values of detection times of respective biological information and body motion information. However, the invention is not limited to this. For example, a target value of at least one of biological information and body motion information and a target value of a detection time of at least one of biological information and body motion information may be respectively set.

In the first to third embodiments, the company terminals 8 and 8A output an analysis result of biological information and body motion information. However, the invention is not limited to this. For example, the company terminals 8, 8A, and 8B may transmit an analysis result of biological information and body motion information to the detecting apparatuses 2A and 2B. The detecting apparatuses 2A and 2B, which receives the analysis result, may display the analysis result on the display unit 241. Further, in the fourth embodiment, the server 91 may transmit the analysis result to the detecting apparatus 2B. The detecting apparatus 2B, which receives the analysis result, may display the analysis result on the display unit 241.

In the embodiments, the receiving unit 23 is configured by the GPS reception circuit. However, the invention is not limited to this. For example, the receiving unit 23 may be configured to receive a standard radio wave and may acquire time information on the basis of the standard radio wave. When information is received in a packet form from a server of a company terminal or a data center, the clocked present date and time may be corrected from information indicating transmission date and time included in the packet.

In the embodiments, the clocking unit 274 acquires date and time information from a satellite signal transmitted from a GPS satellite and corrects the present date and time on the basis of the data and time information. However, the invention is not limited to this. For example, the receiving unit 23 does not have to be provided. The present date and time does not have to be corrected.

In the first and second embodiments, the time-limit determining unit 277 determines whether the number of remaining days to a return due date is one day or less. However, the invention is not limited to this. For example, the number of days compared with the number of remaining days to the return due date may be two or more or may be zero. That is, the number of days can be changed as appropriate.

In the first embodiment, the detecting apparatus 2 may be connected to the external apparatus via the relay apparatus such as a cradle. In this case, for example, when the detecting apparatus 2 is mounted on the cradle, biological information, body motion information, time limit information, and the like stored in the storing unit 26 may be erased.

In the embodiments, the time-limit adjusting unit updates time limit information stored in the storing unit to time limit information in which a date obtained by adding, to a return due date indicated by time limit information, the number of days based on a result obtained by dividing a necessary information amount to a target value (a value obtained by subtracting the present information amount from the target value) by a detection information amount per one day is set as a new return due date. However, the invention is not limited to this. For example, the time limit information may be extended by a predetermined period, for example, one day irrespective of various data amounts and detection times in shortage.

In the embodiments, the target setting unit 280 sets, as target values, information amounts of biological information and body motion information that can be acquired or should be acquired before a return time limit set in advance. However, the invention is not limited to this. For example, information amounts obtained by adding a predetermined information amount to information amounts necessary for an analysis of biological information and body motion information executed in the company terminals 8, 8A, and 8B and the server 91 may be set as the target values. Consequently, it is possible to surely execute the analysis of biological information and body motion information in the company terminals 8, 8A, and 8B and the server 91.

In the third and fourth embodiments, the time-limit determining unit 859 determines whether one day has elapsed after biological information is detected. However, the invention is not limited to this. For example, the time-limit determining unit 859 may determine whether twelve hours have elapsed. In this case, target values of data amounts and the like of biological information may be set at every twelve hours. As explained above, the time-limit determining unit 859 may determine whether the present time reaches predetermined time.

In the embodiments, when degrees of achievement with respect to the target values can be acquired, the detecting apparatus causes the display unit 241 to display the degrees of achievement. However, the invention is not limited to this. For example, the detecting apparatus may display any one or any two of degrees of achievement with respect to target values of information amounts of respective biological information and body motion information and degrees of achievement with respect to target values of detection times of respective biological information and body motion information. Note that the detecting apparatus may notify ratios to the target values using vibration of the vibrating unit 243 without displaying the ratios on the display unit 241. Further, the detecting apparatus may be configured to retain target values, calculate degrees of achievement with respect to the target values, and display the degrees of achievement always or according to necessity. Such a configuration is adopted, for example, when predetermined input operation by the user is performed or when the comparison result is displayed.

In the fourth embodiment, the company terminal 8C and the detecting apparatus 2B can communicate with only the data center 9. However, the invention is not limited to this. For example, the company terminal 8C and the detecting apparatus 2B may be able to communicate with each other.

In the embodiments, the rental company rents the detecting apparatus to the user. The rental company may be a medical institution.

In the embodiments, the detecting apparatuses 2, 2A, and 2B are configured in a wristwatch type. A wearing part of the detecting apparatuses 2, 2A, and 2B is the wrist of the user. However, the invention is not limited to this. For example, the wearing part may be the ankle, the chest, the abdomen, or the like.

In the embodiments, the rental company rents out the biological information detecting apparatuses 2, 2A, and 2B to the user. Therefore, it is assumed that the biological information detecting apparatuses 2, 2A, and 2B in the embodiments are shared by a plurality of users because of the characteristics of rental to users. However, when a user uses an apparatus worn by another user for a long time, it is likely that the user physiologically feels unpleasant or a sanitary problem occurs.

Therefore, the biological information detecting apparatuses 2, 2A, and 2B in the embodiments may include amain body unit including at least the detecting unit 22 and a fixing unit (e.g., a belt of resin) for fixing the main body unit to the body of the user. The main body unit and the fixing unit may be configured separable and only the main body unit may be rented.

For example, when the entire apparatus is rented, when the biological information detecting apparatuses 2, 2A, and 2B are returned from the user, the rental company can initialize data of the biological information detecting apparatuses 2, 2A, and 2B and separate the main body unit and the fixing unit. The rental company can clean the fixing unit, attach the main body unit to the cleaned fixing unit or another new fixing unit, and rent out the apparatus in a clean state to another user.

Consequently, the user can comfortably use the rented biological information detecting apparatuses 2, 2A, and 2B without physiologically feeling unpleasant or without a sanitary problem. On the other hand, the rental company can easily reuse the biological information detecting apparatuses 2, 2A, and 2B.

In the fifth and sixth embodiments, the time-limit adjusting units 282D and 282E adjust time limit information on the basis of the extended use time limit. However, the invention is not limited to this. For example, the time-limit adjusting unit 282E may adjust, without displaying the setting screen, the time limit information to the next day of a day to which the present date and time belongs (e.g., if the present date and time is 17:25 on Apr. 4, 2015, 23:59 on Apr. 5, 2015).

In the fifth and sixth embodiments, when it is determined in step S27 that a return time limit has expired, the second message screen SC2 and the third message screen SC3 functioning as a selection screen for causing the user to select whether the return time limit is extended are displayed on the display unit 241. However, the invention is not limited to this. For example, the notification control units 272D and 272E of the detecting apparatuses 2D and 2E may control the vibrating unit 243 to vibrate to thereby notify that the return time limit is extended or control the operation unit 21 to execute operation for extending the time limit information and operation for not extending the time limit information.

In the fifth and sixth embodiments, when it is determined in the determination processing in steps S74 and S79 that extension operation is performed by the user, the notification control unit 272D causes the display unit 241 to display a not-shown setting screen for setting extended use time limits of the detecting apparatuses 2D and 2E. However, the invention is not limited to this. For example, the notification control unit 272D does not have to cause the display unit 241 to display the setting screen. In this case, for example, a return time limit of the detecting apparatuses 2D and 2E may be automatically extended by predetermined days (e.g., three days).

In the embodiments, the operation unit 21 is configured by physical keys, a touch panel, and the like provided on the housings of the detecting apparatuses 2, 2A, and 2B. However, the invention is not limited to this. For example, the detecting apparatus may detect tap operation of the user as input operation. In this case, the detecting apparatus only has to determine, on the basis of an acceleration value detected by the body-motion-information detecting unit 222, whether the tap operation is performed. Alternatively, a detecting unit capable of detecting the tap operation may be separately provided.

What is claimed is:

1. A biological information detecting apparatus that detects biological information of a user, the biological information detecting apparatus comprising:
a biological-information detecting unit configured to detect the biological information;
a clocking unit configured to clock a present date and time;
a storing unit configured to store time limit information concerning a return time limit of the biological information detecting apparatus; and
an notifying unit configured to notify a comparison result of the return time limit and the present date and time clocked by the clocking unit.

2. The biological information detecting apparatus according to claim 1, further comprising a time-limit adjusting unit configured to adjust the time limit information on the basis of a detection progress state of the biological information detecting apparatus.

3. The biological information detecting apparatus according to claim 2, further comprising a biological-detection-state-information acquiring unit configured to acquire, as information indicating the detection progress state, biological detection state information concerning at least one of a detection time of the biological information by the biological-information detecting unit and an information amount of the detected biological information, wherein
the time-limit adjusting unit adjusts the time limit information on the basis of the biological detection state information.

4. The biological information detecting apparatus according to claim 3, further comprising a biological-detection-state determining unit configured to determine whether the biological detection state information at present has reached an acquisition target of the detection progress state, wherein
the time-limit adjusting unit adjusts the time limit information when the biological-detection-state determining unit determines that the biological detection state information at the present does not reach the acquisition target.

5. The biological information detecting apparatus according to claim 4, wherein the notifying unit includes a display unit configured to display the biological information detected by the biological-information detecting unit and a degree of achievement of the biological detection state information at the present with respect to the acquisition target.

6. The biological information detecting apparatus according to claim 3, wherein the biological detection state information includes, as the information concerning the detection time of the biological information, at least any one of a total time, which is a total of the detection time, a time-period total time, which is a total of the detection time in a predetermined period of time, and a ratio of the detection time in each period of time in the total time.

7. The biological information detecting apparatus according to claim 2, further comprising:
a body-motion-information detecting unit configured to detect body motion information of the user; and
a body-motion-detection-state-information acquiring unit configured to acquire, as information indicating the detection progress state, body motion detection state information concerning at least one of a detection time of the body motion information by the body-motion-information detecting unit and an information amount of the detected body motion information, wherein
the time-limit adjusting unit adjusts the time limit information on the basis of the body motion detection state information.

8. The biological information detecting apparatus according to claim 7, further comprising a body-motion-detection-state determining unit configured to determine whether the body motion detection state information at the present has reached an acquisition target of the detection progress state, wherein
when the body-motion-detection-state determining unit determines that the body motion detection state information at the present does not reach the acquisition target, the time-limit adjusting unit adjusts the time limit information.

9. The biological information detecting apparatus according to claim 1, further comprising a transmitting unit configured to transmit a detection result by the biological information detecting apparatus to an external apparatus.

10. The biological information detecting apparatus according to claim 1, further comprising a receiving unit configured to receive date and time information indicating a present time, wherein
the clocking unit corrects the clocked present date and time on the basis of the received date and time information.

11. A biological information detecting system comprising:
the biological information detecting apparatus according to claim 1; and
an external apparatus configured to communicate with the biological information detecting apparatus, wherein
the biological information detecting apparatus includes an information acquiring unit configured to acquire the time limit information from the external apparatus and causes the storing unit to store the time limit information.

12. A biological information detecting system comprising:
a detecting apparatus rented out to a user and used by the user; and
a managing apparatus configured to manage the detecting apparatus, wherein
the detecting apparatus includes:
a biological-information detecting unit configured to detect biological information of the user;
a clocking unit configured to clock a present date and time;
a storing unit configured to store time limit information concerning a return time limit of the detecting apparatus;
an information acquiring unit configured to acquire the time limit information concerning a return time limit of the detecting apparatus from the managing apparatus;
an notifying unit configured to notify a comparison result of the return time limit and the present date and time clocked by the clocking unit;
a biological-detection-state-information acquiring unit configured to acquire biological detection state information concerning at least one of a detection time of the biological information by the biological-information detecting unit and an information amount of the detected biological information;
a biological-detection-state determining unit configured to determine whether the biological detection state information at present has reached an acquisition target; and
an adjustment requesting unit configured to cause the managing apparatus to adjust the time limit information when the biological detection state information at the present is determined not reach the acquisition target, and
the managing apparatus includes:
an adjustment-request receiving unit configured to receive the request information;
a time-limit adjusting unit configured to adjust the time limit information on the basis of the received request information; and
an information transmitting unit configured to transmit the adjusted time limit information to the detecting apparatus.

13. A biological information detecting system comprising:
a detecting apparatus rented out to a user and used by the user; and
a managing apparatus configured to manage the detecting apparatus, wherein
the detecting apparatus includes:
a biological-information detecting unit configured to detect biological information of the user;
a clocking unit configured to clock a present date and time;
a storing unit configured to store time limit information concerning a return time limit of the detecting apparatus;
an information acquiring unit configured to acquire the time limit information concerning a return time limit of the detecting apparatus from the managing apparatus;
an notifying unit configured to notify a comparison result of the return time limit and the present date and time clocked by the clocking unit; and
a biological-information transmitting unit configured to transmit the biological information detected by the biological-information detecting unit, and
the managing apparatus includes:
a biological-information receiving unit configured to receive the biological information and the biological detection state information;
a biological-detection-state determining unit configured to determine whether the biological detection state information at present including at least one of a detection time of the biological information and an information amount of the detected biological information has reached an acquisition target;
a time-limit adjusting unit configured to adjust the time limit information when the biological detection state information at the present is determined not reach the acquisition target; and
an information transmitting and outputting unit configured to transmit and output the adjusted time limit information to the detecting apparatus.

14. A control method for the biological information detecting apparatus according to claim 1, comprising:
determining whether the return time limit has expired;
stopping the detection of biological information by the biological-information detecting unit when it is determined that the return time limit has expired;
causing, after the detection of biological information is stopped, the user to select whether the return time limit is extended;
causing, when the return time limit is extended, the biological-information detecting unit to resume the detection of biological information.

15. A control method for the biological information detecting apparatus according to claim 2, comprising:
determining whether the return time limit has expired;
stopping the detection of biological information by the biological-information detecting unit when it is determined that the return time limit has expired;
causing, after the detection of biological information is stopped, the user to select whether the return time limit is extended;
causing, when the return time limit is extended, the biological-information detecting unit to resume the detection of biological information.

16. A control method for the biological information detecting apparatus according to claim 3, comprising:
determining whether the return time limit has expired;
stopping the detection of biological information by the biological-information detecting unit when it is determined that the return time limit has expired;
causing, after the detection of biological information is stopped, the user to select whether the return time limit is extended;
causing, when the return time limit is extended, the biological-information detecting unit to resume the detection of biological information.

17. The control method for the biological information detecting apparatus according to claim 14, wherein
the notifying unit includes a display unit, and
when it is determined that the return time limit has expired, the display unit is caused to display a selection screen for causing the user to select whether the return time limit is extended.

18. A control method for the biological information detecting apparatus according to claim 1, the notifying unit including a display unit configured to display the biological information,
the control method comprising:
determining whether the return time limit has expired;
regulating, when it is determined that the return time limit has expired, the display unit from being caused to display the biological information detected by the biological-information detecting unit;
causing, after the display of the biological information is regulated, the user to select whether the return time limit is extended; and
causing, when the return time limit is extended, the display unit to display the biological information again.

19. A control method for the biological information detecting apparatus according to claim 2, the notifying unit including a display unit configured to display the biological information,
the control method comprising:
determining whether the return time limit has expired;
regulating, when it is determined that the return time limit has expired, the display unit from being caused to display the biological information detected by the biological-information detecting unit;
causing, after the display of the biological information is regulated, the user to select whether the return time limit is extended; and
causing, when the return time limit is extended, the display unit to display the biological information again.

20. A control method for the biological information detecting apparatus according to claim 3, the notifying unit including a display unit configured to display the biological information,
the control method comprising:
determining whether the return time limit has expired;
regulating, when it is determined that the return time limit has expired, the display unit from being caused to display the biological information detected by the biological-information detecting unit;
causing, after the display of the biological information is regulated, the user to select whether the return time limit is extended; and
causing, when the return time limit is extended, the display unit to display the biological information again.
